(19) United States
(12) Patent Application Publication
(10) Pub. No.: US 2026/0370286 A1
(43) Pub. Date: Nov. 19, 2026

(54) CODEBOOK-BASED TRAINING DATASET REPORTS FOR CHANNEL STATE INFORMATION

(71) Applicant: Lenovo (Singapore) Pte. Limited, Singapore (SG)

(72) Inventors: Ahmed Hindy, Aurora, IL (US); Vahid Pourahmadi, München (DE); Venkata Srinivas Kothapalli, Aurora, IL (US); Vijay Nangia, Woodridge, IN (US)

(73) Assignee: Lenovo (Singapore) Pte. Limited, Singapore (SG)

(21) Appl. No.: 19/138,312

(22) PCT Filed: Dec. 5, 2023
(86) PCT No.: PCT/IB2023/062268

§ 371 Date: Jun. 12, 2025

Related U.S. Application Data
(60) Provisional application No. 63/387,653, filed on Dec. 15, 2022.

(51) Int. Cl. H04B 7/06

(52) U.S. Cl. CPC H04B 7/0626; H04B 7/063; H04B 7/0632; H04B 7/0639

(57) ABSTRACT

Various aspects of the present disclosure relate to codebook-based training dataset reports for channel state information (CSI). A training dataset report is generated or obtained that corresponds to CSI based on a precoding matrix indicator (PMI) codebook. The training dataset report includes multiple parameters corresponding to the PMI codebook and weight values associated with those parameters. These parameters are aggregations of similar training dataset points corresponding to CSI and the weight values are indications of rates of occurrence of the similar training dataset points. The training dataset report is then transmitted to another device (e.g., a network entity or a UE).

### RELATED APPLICATION

This application claims priority to U.S. patent application Ser. No. 63/387,653 filed Dec. 15, 2022 entitled “CODEBOOK-BASED TRAINING DATASET REPORTS FOR CHANNEL STATE INFORMATION,” the disclosure of which is incorporated by reference herein in its entirety.

### TECHNICAL FIELD

The present disclosure relates to wireless communications, and more specifically to training dataset reports for channel state information (CSI).

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

In the wireless communications system, CSI feedback can be transmitted from a UE to a base station (e.g., a gNB). The CSI feedback provides the base station with an indication of the quality of a channel at a particular time.

### SUMMARY

The present disclosure relates to methods, apparatuses, and systems that support codebook-based training dataset reports for CSI. A training dataset report is generated or obtained that corresponds to CSI based on a precoding matrix indicator (PMI) codebook. The training dataset report includes multiple parameters corresponding to the PMI codebook and weight values associated with those parameters. These parameters are aggregations of similar training dataset points corresponding to CSI and the weight values are indications of rates of occurrence of the similar training dataset points. The training dataset report is then transmitted to another device (e.g., a network entity or a UE). By using these multiple parameters and associated weight values, the size of the training dataset report can be reduced because all of the training dataset points need not be included individually in the training dataset report.

Some implementations of the method and apparatuses described herein may further include to: obtain a training dataset report corresponding to CSI based on a PMI codebook, wherein the training dataset report includes multiple parameters corresponding to the PMI codebook, the multiple parameters associated with multiple weight values; and transmit, to a device, a first signaling indicating the training dataset report.

In some implementations of the method and apparatuses described herein, the apparatus comprises a user equipment, and the method and apparatuses further include to transmit the first signaling over a physical uplink channel. Additionally or alternatively, the apparatus comprises a UE, and the method and apparatus further include to transmit the first signaling over a physical downlink channel, to transmit the first signaling as part of a higher-layer configuration information, or a combination thereof. Additionally or alternatively, the multiple parameters comprise a first set of codepoints and each codepoint of the first set of codepoints corresponds to a selected subset of spatial-domain basis indices, frequency-domain basis indices, time-domain basis indices, or a combination thereof. Additionally or alternatively, the first set of codepoints is a subset of a second set of codepoints, each codepoint of the second set of codepoints corresponding to a subset of spatial-domain basis indices, frequency-domain basis indices, time-domain basis indices, or a combination thereof. Additionally or alternatively, the multiple parameters comprise a set of entries corresponding to a bitmap that identifies reported coefficients with non-zero amplitude values. Additionally or alternatively, each entry of the set of entries corresponds to a likelihood of a coefficient having a non-zero amplitude value. Additionally or alternatively, the multiple parameters comprise a set of codepoints and each codepoint of the set of codepoints corresponds to at least one of a set of coefficient amplitude values and a set of coefficient phase values that are associated with multiple consecutive spatial-domain basis indices, multiple consecutive frequency-domain basis indices, multiple consecutive time-domain basis indices, or a combination thereof. Additionally or alternatively, each codepoint of the set of codepoints is associated with one of two coefficient types, wherein a first coefficient type of the two coefficient types is associated with a first set of spatial-domain basis indices, frequency-domain basis indices, time-domain basis indices, or a combination thereof, and wherein a second coefficient type of the two coefficient types is associated with a second set of spatial-domain basis indices, frequency-domain basis indices, time-domain basis indices, or a combination thereof. Additionally or alternatively, the first set of spatial-domain basis indices, frequency-domain basis indices, time-domain basis indices are associated with a strongest coefficient with a largest amplitude value. Additionally or alternatively, the multiple parameters comprise a set of rank indicator values and each rank indicator value of the set of rank indicator values is associated with a distinct weight. Additionally or alternatively, the multiple parameters comprise a set of channel quality indicator values and each channel quality indicator value of the set of channel quality indicator values is associated with a distinct weight. Additionally or alternatively, the method and apparatus further include to obtain a CSI report that is based on the training dataset report, wherein the CSI report includes parameters corresponding to spatial-domain basis indices, frequency-domain basis indices, time-domain basis indices, a bitmap indicator, a set of indicators corresponding to amplitude values of non-zero coefficients, a set of indicators corresponding to phase values of non-zero coefficients, a rank indicator (RI) value, a channel quality indicator (CQI) value, or a combination thereof, and each of the parameters of the CSI report is mapped to a set of values that are encoded via an encoding scheme based on the multiple weight values included in the training dataset report; and transmit, to the device, a second signaling indicating the CSI report.

Some implementations of the method and apparatuses described herein may further include to: receive, from a device, a first signaling indicating a training dataset report; and wherein the training dataset report corresponds to CSI based on a PMI codebook, wherein the training dataset report includes multiple parameters corresponding to the PMI codebook, the multiple parameters associated with multiple weight values.

In some implementations of the method and apparatuses described herein, the device comprises a user equipment, and the method and apparatuses further include to receive the first signaling over a physical uplink channel. Additionally or alternatively, the apparatus comprises a user equipment, and the method and apparatuses further include to cause the apparatus to receive the first signaling over a physical downlink channel, to receive the first signaling as part of a higher-layer configuration information, or a combination thereof. Additionally or alternatively, the multiple parameters comprise a first set of codepoints and each codepoint of the first set of codepoints corresponds to a selected subset of spatial-domain basis indices, frequency-domain basis indices, time-domain basis indices, or a combination thereof. Additionally or alternatively, the first set of codepoints is a subset of a second set of codepoints, each codepoint of the second set of codepoints corresponding to a subset of spatial-domain basis indices, frequency-domain basis indices, time-domain basis indices, or a combination thereof. Additionally or alternatively, the multiple parameters comprise a set of entries corresponding to a bitmap that identifies reported coefficients with non-zero amplitude values. Additionally or alternatively, each entry of the set of entries corresponds to a likelihood of a coefficient having a non-zero amplitude value. Additionally or alternatively, the multiple parameters comprise a set of codepoints and each codepoint of the set of codepoints corresponds to at least one of a set of coefficient amplitude values and a set of coefficient phase values that are associated with multiple consecutive spatial-domain basis indices, multiple consecutive frequency-domain basis indices, multiple consecutive time-domain basis indices, or a combination thereof. Additionally or alternatively, each codepoint of the set of codepoints is associated with one of two coefficient types, wherein a first coefficient type of the two coefficient types is associated with a first set of spatial-domain basis indices, frequency-domain basis indices, time-domain basis indices, or a combination thereof, and wherein a second coefficient type of the two coefficient types is associated with a second set of spatial-domain basis indices, frequency-domain basis indices, time-domain basis indices, or a combination thereof. Additionally or alternatively, the first set of spatial-domain basis indices, frequency-domain basis indices, time-domain basis indices are associated with a strongest coefficient with a largest amplitude value. Additionally or alternatively, the multiple parameters comprise a set of rank indicator values and each rank indicator value of the set of rank indicator values is associated with a distinct weight. Additionally or alternatively, the multiple parameters comprise a set of channel quality indicator values and each channel quality indicator value of the set of channel quality indicator values is associated with a distinct weight. Additionally or alternatively, the method and apparatuses further include to receive, from the device, a second signaling indicating a CSI report; and wherein the CSI report is based on the training dataset report, wherein the CSI report includes parameters corresponding to spatial-domain basis indices, frequency-domain basis indices, time-domain basis indices, a bitmap indicator, a set of indicators corresponding to amplitude values of non-zero coefficients, a set of indicators corresponding to phase values of non-zero coefficients, a RI value, a CQI value, or a combination thereof, and each of the parameters of the CSI report is mapped to a set of values that are encoded via an encoding scheme based on the multiple weight values included in the training dataset report.

### BRIEF DESCRIPTION OF THE DRAWINGS

FIG. 1 illustrates an example of a wireless communications system that supports codebook-based training dataset reports for channel state information in accordance with aspects of the present disclosure.

FIG. 2 illustrates an aperiodic trigger state defining a list of CSI report settings.

FIG. 3 illustrates an information element pertaining to CSI reporting.

FIG. 4 illustrates an information element for Radio Resource Control (RRC) configuration for wireless resources.

FIG. 5 illustrates a scenario for partial CSI omission for physical uplink shared channel (PUSCH)-based CSI.

FIGS. 6 and 7 illustrate an example of a block diagram of a device that supports codebook-based training dataset reports for channel state information in accordance with aspects of the present disclosure.

FIGS. 8 through 15 illustrate flowcharts of methods that support codebook-based training dataset reports for channel state information in accordance with aspects of the present disclosure.

### DETAILED DESCRIPTION

CSI feedback in frequency-division duplexing (FDD) networks is reported by the UE to the network, where the CSI feedback is compressed via transformation of the channel over the spatial domain, frequency domain, or both, with pre-determined sets of spatial and frequency basis vectors, respectively. In addition to conventional CSI feedback mechanisms, artificial intelligence/machine learning (AI/ML)-enabled CSI acquisition schemes may be used. These AI/ML-enabled schemes would provide some feedback from the UE to the network corresponding to CSI components that cannot be inferred from the AI/ML model, e.g., CSI components that are statistically independent over time and hence cannot be inferred from the training data. Additionally, obtaining ubiquitous training data for the AI/ML-enabled schemes allows the robustness of the AI/ML-enabled CSI acquisition scheme to be maintained against variations in the environment that would lead to drifts in the channel distribution and hence requires updating the AI/ML model.

Accordingly, discussed herein are CSI feedback techniques including training data, where the training data is aggregated such that similar training dataset points are fed back once, associated with a weight coefficient corresponding to the probability (e.g., the rate of occurrence) of that dataset point. A training dataset report generation system feeds back parameters identifying these similar training dataset points as well as their weight values in a training dataset report. The training dataset report generation system may also include likelihood ratios of whether a given coefficient corresponding to a channel or precoding matrix is associated with a non-zero amplitude value, where the likelihood ratios are based on the weight or rate of occurrence of a given CSI datapoint as part of the training dataset point.

The training dataset report generation system may also infer characteristics of the channel distribution based on the training dataset, such that CSI feedback can utilize distribution-aware data compression schemes (e.g., Huffman coding). For example, CSI parameters may be encoded such that values with higher likelihood of occurrence are mapped to a shorter sequence of bits, and CSI parameters are encoded such that values with lower likelihood of occurrence are mapped to a longer sequence of bits.

Other solutions for providing CSI feedback for training an AI/ML model include Type-I and Type-II codebook-based CSI reports, and generating CSI reports that include all of the training dataset points. The techniques discussed herein reduce the amount of data that needs to be included in a training dataset report because all of the training dataset points need not be included individually in the training dataset report. This reduces the size of the training dataset report and the amount of time and bandwidth consumed in transmitting the training dataset report. Additionally, the total number of datapoints gathered for the CSI is large, but the techniques discussed herein process those datapoints to generate a smaller number of parameters (and associated weights), reducing the complexity of the devices needing to account for a large number of datapoints when training the AI/ML model.

Aspects of the present disclosure are described in the context of a wireless communications system. Aspects of the present disclosure are further illustrated and described with reference to device diagrams and flowcharts.

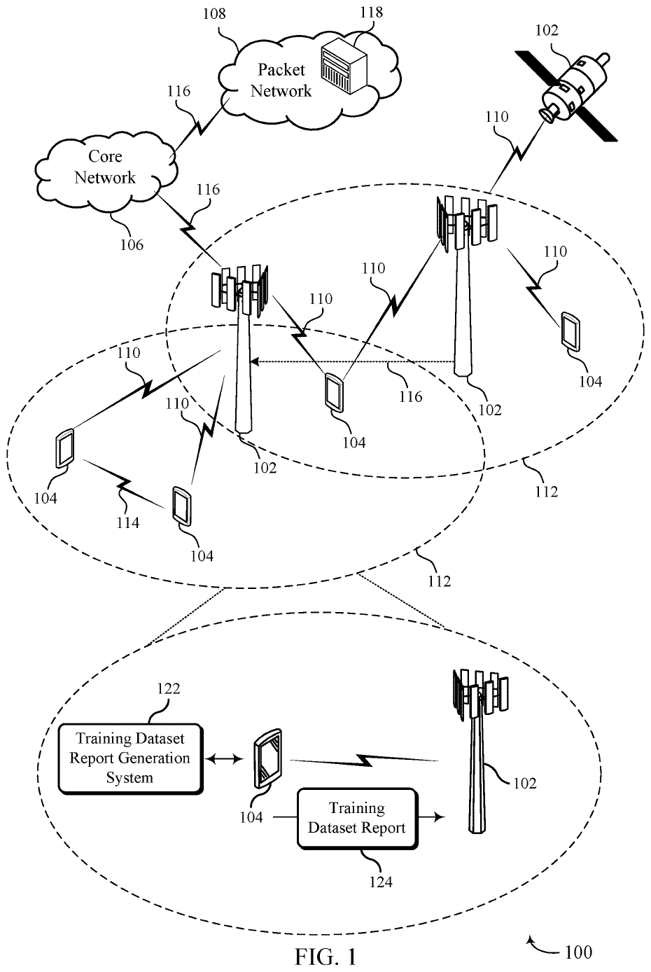

FIG. 1 illustrates an example of a wireless communications system 100 that supports codebook-based training dataset reports for channel state information in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N6, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N6, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communication system 100 (e.g., time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., p=0) may be associated with a first subcarrier spacing (e.g., 15 kHz) and a normal cyclic prefix. The first numerology (e.g., p=0) associated with the first subcarrier spacing (e.g., 15 kHz) may utilize one slot per subframe. A second numerology (e.g., p=1) may be associated with a second subcarrier spacing (e.g., 30 kHz) and a normal cyclic prefix. A third numerology (e.g., p=2) may be associated with a third subcarrier spacing (e.g., 60 kHz) and a normal cyclic prefix or an extended cyclic prefix. A fourth numerology (e.g., p=³) may be associated with a fourth subcarrier spacing (e.g., 120 kHz) and a normal cyclic prefix. A fifth numerology (e.g., p=⁴) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., p=0), which includes 15 kHz subcarrier spacing; a second numerology (e.g., p=1), which includes 30 kHz subcarrier spacing; and a third numerology (e.g., p=2), which includes 60 kHz subcarrier spacing. FR2 may be associated with one or multiple numerologies (e.g., at least 2 numerologies). For example, FR2 may be associated with a third numerology (e.g., p=2), which includes 60 kHz subcarrier spacing; and a fourth numerology (e.g., p=3), which includes 120 kHz subcarrier spacing.

The UE 104 includes a training dataset report generation system 122 that generates a training dataset report 124 that is transmitted to the network entity 102. Additionally or alternatively, the network entity 102 includes a training dataset report generation system 122 that generates a training dataset report that is transmitted to the UE 104. The training dataset report generation system generates a training dataset report that includes multiple parameters corresponding to a PMI codebook and weight values associated with those parameters. These parameters are aggregations of similar training dataset points corresponding to CSI and the weight values are indications of rates of occurrence of the similar training dataset points. The training dataset report is then transmitted to another device (e.g., to the network entity 102). The device receiving the training dataset report may then use the training dataset report to train an AI/ML model for identifying subsequently received CSI feedback.

Communication between devices discussed herein, such as between UEs 104 and network entities 102, is performed using any of a variety of different signaling. For example, such signaling can be any of various messages, requests, or responses, such as triggering messages, configuration messages, and so forth. By way of another example, such signaling can be any of various signaling mediums or protocols over which messages are conveyed, such as any combination of a physical downlink shared channel (PDSCH), a physical downlink control channel (PDCCH), a physical uplink shared channel (PUSCH), a physical uplink control channel (PUCCH), radio resource control (RRC), downlink control information (DCI), uplink control information (UCI), sidelink control information (SCI), medium access control element (MAC-CE), sidelink positioning protocol (SLPP), PC5 radio resource control (PC5-RRC) and so forth.

In some wireless communications systems, details are provided for NR Type-II codebook. For instance, assume that a gNB is equipped with a two-dimensional (2D) antenna array with N₁, N2 antenna ports per polarization placed horizontally and vertically and communication occurs over N3 Precoder Matrix Indicator (PMI) sub-bands. A PMI subband can consist of a set of resource blocks, each resource block consisting of a set of subcarriers. In such case, 2N₁N₂ Channel State Information (CSI)-Reference Signal (RS) ports can be utilized to enable downlink (DL) channel estimation with high resolution for NR Rel. 15 Type-II codebook. In order to reduce the uplink (UL) feedback overhead, a Discrete Fourier transform (DFT)-based CSI compression of the spatial domain can be applied to L dimensions per polarization, where L<N₁N₂. In the sequel the indices of the 2 L dimensions can be referred as the Spatial Domain (SD) basis indices. The magnitude and phase values of the linear combination coefficients for each sub-band can be fed back to the gNB as part of the CSI report. The 2N₁N₂×N₃ codebook per layer/can take on the form

Wₗ=W₁W_{2,l},

where W₁ is a 2N₁N₂×2 L block-diagonal matrix (L<N₁N₂) with two identical diagonal blocks, e.g.,

$${W}_{1} = [ \begin{matrix}B & 0 \\ 0 & B\end{matrix} ] ,$$

and B is an N₁N₂×L matrix with columns drawn from a 2D oversampled DFT matrix, as follows.

$${u}_{m} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}} ] ,\end{matrix}$$

$${v}_{l , m} = [ \begin{matrix}{u}_{m} & {e}^{j \frac{2 π l}{{O}_{1} {N}_{1}}} {u}_{m} & … & {{e}^{j \frac{2 π l ( {N}_{1} - 1 )}{{O}_{1} {N}_{1}}} {u}_{m} ]}^{T}\end{matrix} ,$$

$$\begin{matrix}B = \begin{matrix}[ {v}_{{l}_{0} , {m}_{0}} & {v}_{{l}_{1} , {m}_{1}} & … & {v}_{{l}_{L - 1} , {m}_{L - 1}} ] ,\end{matrix} \\ {l}_{i} = {O}_{1} {n}_{1}^{( i )} + {q}_{1} , 0 \leq {n}_{1}^{( i )} < {N}_{1} , 0 \leq {q}_{1} < {O}_{1} , \\ {m}_{i} = {O}_{2} {n}_{2}^{( i )} + {q}_{2} , 0 \leq {n}_{2}^{( i )} < {N}_{2} , 0 \leq {q}_{2} < {O}_{2} ,\end{matrix}$$

where the superscript^{T} denotes a matrix transposition operation. Note that O₁, O₂ oversampling factors can be assumed for the 2D DFT matrix from which matrix B is drawn. Note that W₁ can be common across all layers. W_{2,l} is a 2 L×N₃ matrix, where the i^{th} column corresponds to the linear combination coefficients of the 2 L beams in the i^{th} sub-band. Only the indices of the L selected columns of B can be reported, along with the oversampling index taking on O₁O₂ values. Note that W_{2,l} can be independent for different layers.

In some wireless communications systems, details are provided for NR Type-II port selection codebook. For instance, for Type-II Port Selection codebook, K (where K≤2N₁N₂) beamformed CSI-RS ports can be utilized in DL transmission, in order to reduce complexity. The K×N₃ codebook matrix per layer takes on the form

$${W}_{l} = {W}_{1}^{PS} {W}_{2 , l} .$$

Here, W₂ may follow the same structure as the conventional NR Rel. 15 Type-II Codebook, and is layer specific.

$${W}_{1}^{PS}$$

is a K×2 L block-diagonal matrix with two identical diagonal blocks, e.g.,

$${W}_{1}^{PS} = [ \begin{matrix}E & 0 \\ 0 & E\end{matrix} ] ,$$

### and E is an

$$\frac{K}{2} \times L$$

matrix whose columns are standard unit vectors, as follows.

$$E = [ \begin{matrix}{e}_{mod ( {m}_{P S} {d}_{P S} , K / 2 )}^{( K / 2 )} & {e}_{mod ( {m}_{PS} {d}_{PS} + 1 , K / 2 )}^{( K / 2 )} & … & {e}_{mod ( {m}_{PS} {d}_{PS} + L - 1 , K / 2 )}^{( K / 2 )} ] ,\end{matrix} where {e}_{i}^{( K )}$$

is a standard unit vector with a 1 at the i^{th} location. Here d_{PS} is an RRC parameter which takes on the values {1, 2, 3, 4} under the condition d_{PS}≤min(K/2, L), whereas m_{PS} takes on the values

$$\{ 0 , … , ⌈ \frac{K}{2 {d}_{P S}} ⌉ - 1 \}$$

and is reported as part of the UL CSI feedback overhead. W₁ is common across all layers.

For K=16, L=4 and d_{PS}=1, the 8 possible realizations of E corresponding to m_{PS}={0,1, . . . , 7} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] , [ \begin{matrix}0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] , [ \begin{matrix}0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0\end{matrix} ] .$$

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] .$$

When d_{PS}=3, the 3 possible realizations of E corresponding of m_{PS}={0,1,2} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1 \\ 0 & 0 & 0 & 0\end{matrix} ] , [ \begin{matrix}0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0\end{matrix} ] .$$

When d_{PS}=4, the 2 possible realizations of E corresponding of m_{PS}={0,1} are as follows

$$[ \begin{matrix}1 & 0 & 0 & 0 \\ 0 & 1 & 0 & 0 \\ 0 & 0 & 1 & 0 \\ 0 & 0 & 0 & 1 \\ 0 & 0 & 0 & 0 \\ 0 & 0 & 0 & 0 \\ 0 & 0 & 0 & 0 \\ 0 & 0 & 0 & 0\end{matrix} ] , [ \begin{matrix}0 & 0 & 0 & 0 \\ 0 & 0 & 0 & 0 \\ 0 & 0 & 0 & 0 \\ 0 & 0 & 0 & 0 \\ 1 & 0 & 0 & 0 \\ 0 & 1 & 0 & 0 \\ 0 & 0 & 1 & 0 \\ 0 & 0 & 0 & 1\end{matrix} ] .$$

To summarize, m_{PS} parametrizes the location of the first 1 in the first column of E, whereas d_{PS} represents the row shift corresponding to different values of m_{PS}.

In some wireless communications systems, details are provided for NR Type-I codebook. For instance, NR Rel. 15 Type-I codebook is the baseline codebook for NR, with a variety of configurations. The most common utility of Rel. 15 Type-I codebook is a special case of NR Rel. 15 Type-II codebook with L=1 for RI=1, 2, wherein a phase coupling value is reported for each sub-band, e.g., W_{2,l} is 2×N₃, with the first row equal to [1, 1, . . . , 1] and the second row equal to [e^{j2πØ}^{₀}, . . . , e^{j2πØN}^{₃₋₁}]. Under specific configurations, φ₀=φ₁= . . . =φ_{N}_{₃}−1, e.g., wideband reporting. For RI>2, different beams are used for each pair of layers. NR Rel. 15 Type-I codebook can be depicted as a low-resolution version of NR Rel. 15 Type-II codebook with spatial beam selection per layer-pair and phase combining only.

In some wireless communications systems, details are provided for NR Rel. 16 Type-I codebook. For instance, assume that a gNB is equipped with a two-dimensional (2D) antenna array with N₁, N₂ antenna ports per polarization placed horizontally and vertically and communication occurs over N₃ PMI subbands. A PMI subband consists of a set of resource blocks, each resource block consisting of a set of subcarriers. In such cases, 2N₁N₂N₃ CSI-RS ports can be utilized to enable DL channel estimation with high resolution for NR Rel. 16 Type-II codebook. In order to reduce the UL feedback overhead, a Discrete Fourier transform (DFT)-based CSI compression of the spatial domain can be applied to L dimensions per polarization, where L<N₁N₂. Similarly, additional compression in the frequency domain can be applied, where each beam of the frequency-domain precoding vectors is transformed using an inverse DFT matrix to the delay domain, and the magnitude and phase values of a subset of the delay-domain coefficients can be selected and fed back to the gNB as part of the CSI report. The 2N₁N₂×N₃ codebook per layer takes on the form

Wₗ=W₁\tilde{W}_{2,l}W_{f,l}^{H},

where W₁ is a 2N₁N₂×2 L block-diagonal matrix (L<N₁N₂) with two identical diagonal blocks, e.g.,

$${W}_{1} = [ \begin{matrix}B & 0 \\ 0 & B\end{matrix} ] ,$$

and B is an N₁N₂×L matrix with columns drawn from a 2D oversampled DFT matrix, as follows.

$$\begin{matrix}{u}_{m} = [ \begin{matrix}1 & {e}^{j \frac{2 π m}{{O}_{2} {N}_{2}}} & … & {e}^{j \frac{2 π m ( {N}_{2} - 1 )}{{O}_{2} {N}_{2}}} ] ,\end{matrix} \\ {v}_{l , m} = [ \begin{matrix}{u}_{m} & {e}^{j \frac{2 π l}{{O}_{1} {N}_{1}}} {u}_{m} & … & {{e}^{j \frac{2 π l ( {N}_{1} - 1 )}{{O}_{1} {N}_{1}}} {u}_{m} ]}^{T} ,\end{matrix} \\ B = \begin{matrix}[ {v}_{{l}_{0} , {m}_{0}} & {v}_{{l}_{1} , {m}_{1}} & … & {v}_{{l}_{L - 1} , {m}_{L - 1}} ] ,\end{matrix} \\ {l}_{i} = {O}_{1} {n}_{1}^{( i )} + {q}_{1} , 0 \leq {n}_{1}^{( i )} < {N}_{1} , 0 \leq {q}_{1} < {O}_{1} , \\ {m}_{i} = {O}_{2} {n}_{2}^{( i )} + {q}_{2} , 0 \leq {n}_{2}^{( i )} < {N}_{2} , 0 \leq {q}_{2} < {O}_{2} ,\end{matrix}$$

where the superscript^{T} denotes a matrix transposition operation. Note that O₁, O₂ oversampling factors are assumed for the 2D DFT matrix from which matrix B is drawn. Note that W₁ is common across all layers. W_{f} is an N₃×M matrix (M<N₃) with columns selected from a critically-sampled size-N₃ DFT matrix, as follows

$$\begin{matrix}\begin{matrix}{w}_{f , l} = [ \begin{matrix}{f}_{{k}_{0}} & {f}_{{k}_{1}} & … & {f}_{{k}_{M ′ - 1}}\end{matrix} ] , & 0 \leq {k}_{i} \leq {N}_{3} - 1 ,\end{matrix} \\ {f}_{k} = [ \begin{matrix}1 & {e}^{- j \frac{2 π k}{{N}_{3}}} & … & {{e}^{- j \frac{2 π k ( {N}_{3} - 1 )}{{N}_{3}}} ]}^{T}\end{matrix} .\end{matrix}$$

In some scenarios the indices of the L selected columns of B are reported, along with the oversampling index taking on O₁O₂ values. Similarly, for W_{f,l}, the indices of the M selected columns out of the predefined size-N₃ DFT matrix are reported. In the sequel the indices of the M dimensions can be referred as the selected Frequency Domain (FD) basis indices. Hence, L, M represent the equivalent spatial and frequency dimensions after compression, respectively. Further, the 2 L×MV matrix W₂ represents the linear combination coefficients (LCCs) of the spatial and frequency DFT-basis vectors. Both W₂, W_{f} can be selected independent for different layers. Amplitude and phase values of an approximately β fraction of the 2 LM available coefficients are reported to the gNB (β<1) as part of the CSI report. Note that coefficients with zero amplitude values are indicated via a layer-specific bitmap matrix Sₗ of size 2 L×M, wherein each bit of the bitmap matrix Sₗ indicates whether a coefficient has a zero-amplitude value, wherein for these coefficients no quantized amplitude and phase values need to be reported. Since all non-zero coefficients reported within a layer are normalized with respect to the coefficient with the largest amplitude value (strongest coefficient), wherein the amplitude and phase values corresponding to the strongest coefficient are set to one and zero, respectively, and hence no further amplitude and phase information is explicitly reported for this coefficient, and an indication of the index of the strongest coefficient per layer can be reported.

Hence, for a single-layer transmission, magnitude and phase values of a maximum of [2βLM|−1 coefficients (along with the indices of selected L, M DFT vectors) can be reported per layer, leading to significant reduction in CSI report size, compared with reporting 2N₁N₂×N₃−1 coefficients' information.

For NR Rel. 16 Type-II Port Selection codebook, K (where K≤2N₁N₂) beamformed CSI-RS ports can be utilized in DL transmission, in order to reduce complexity. The K×N₃ codebook matrix per layer takes on the form

$${W}_{l} = {W}_{1}^{PS} {\tilde{W}}_{2 , l} {W}_{f , l}^{H} .$$

Here, \tilde{W}_{2,l} and W_{3,l} follow the same structure as the conventional NR Rel. 16 Type-II Codebook, where both are layer specific. The matrix

$${W}_{1}^{PS}$$

can be a K×2 L block-diagonal matrix with the same structure as that in the NR Rel. 15 Type-II Port Selection Codebook.

The NR Rel. 17 Type-II Port Selection codebook can follow a similar structure as that of Rel. 15 and Rel. 16 port-selection codebooks, as follows

$${W}_{l} = {\overline{W}}_{1}^{PS} {\tilde{W}}_{2 , l} {W}_{f , l}^{H} .$$

However, unlike Rel. 15 and Rel. 16 Type-II port-selection codebooks, the port-selection matrix

$${\overline{W}}_{1}^{PS}$$

supports free selection of the K ports, or more precisely the K/2 ports per polarization out of the N₁N₂ CSI-RS ports per polarization, e.g.,

$$⌈ {log}_{2} ( \begin{matrix}{N}_{1} {N}_{2} \\ K / 2\end{matrix} ) ⌉$$

bits are used to identify the K/2 selected ports per polarization, wherein this selection is common across all layers. Here, W_{2,1} and Wp follow the same structure as the conventional NR Rel. 16 Type-II Codebook, however M can be limited to 1,2 only, with the network configuring a window of size N={2,4} for M=2. Moreover, the bitmap is reported unless p=1 and the UE reports all the coefficients for a rank up to a value of two.

For Rel-18 potential Type-II codebook, the time-domain corresponding to slots is further compressed via DFT-based transformation, wherein the codebook is in the following form

Wₗ=W₁\tilde{W}_{2,l}(W_{f,l}⊗W_{d,l})^{H},

where W₁, W_{f,l} follow the same structure as Rel-16 Type-II codebook, W_{d,l} is an N₄×Q matrix (Q≤N₄) with columns selected from a critically-sampled size-N₄ DFT matrix, as follows

$${W}_{d , l} = [ {d}_{{q}_{0}} {d}_{{q}_{1}} … {d}_{{q}_{Q - 1}} ] , 0 \leq {q}_{i} \leq {N}_{4} - 1 ,$$

$${d}_{q} = [ 1 {e}^{- j \frac{2 π q}{{N}_{4}}} … {e}^{{- j \frac{2 π q ( {N}_{4} - 1 )}{{N}_{4}} ]}^{T}} .$$

Only the indices of the Q selected columns of W_{d,l} can be reported. Note that W_{d,l} may be layer specific, e.g., W_{d,l}≠W_{d,2}, or layer common, i.e., W_{d,1}==W_{d,RI}, where RI corresponds to the total number of layers, and the operator ⊗ corresponds to a Kronecker matrix product. Here, \tilde{W}_{2,l} is a 2 L×MQ sized matrix with layer-specific entries representing the LCCs corresponding to the spatial-domain, frequency-domain and time-domain DFT-basis vectors. Thereby, a size 2 L×MQ bitmap may need to be reported associated with Rel-18 Type-II codebook.

In some scenarios a codebook report is partitioned into two parts based on the priority of information reported. Each part is encoded separately (Part 1 has a possibly higher code rate). A list is presented below the parameters for NR Rel. 16 Type-II codebook.

For content of a CSI report:
Part 1: RI+Channel Quality Indicator (CQI)+Total number of coefficients
Part 2: SD basis indicator+FD basis indicator/layer+Bitmap/layer+Coefficient Amplitude info/layer+Coefficient Phase info/layer+Strongest coefficient indicator/layer

Furthermore, Part 2 CSI can be decomposed into sub-parts each with different priority (higher priority information listed first). Such partitioning can be implemented to allow dynamic reporting size for codebook based on available resources in the uplink phase. Also Type-II codebook can be based on aperiodic CSI reporting, and reported in PUSCH via Downlink Control Information (DCI) triggering (with at least one exception). Type-I codebook can be based on periodic CSI reporting (PUCCH) or semi-persistent CSI reporting (PUSCH or PUCCH) or aperiodic reporting (PUSCH).

For priority reporting for Part 2 CSI, multiple CSI reports may be transmitted with different priorities, as shown in Table 1 below. Note that the priority of the N_{Rep} CSI reports can be based on the following:
1. A CSI report corresponding to one CSI reporting configuration for one cell may have higher priority compared with another CSI report corresponding to one other CSI reporting configuration for the same cell
2. CSI reports intended to one cell may have higher priority compared with other CSI reports intended to another cell
3. CSI reports may have higher priority based on the CSI report content, e.g., CSI reports carrying L1—Reference Signal Received Power (RSRP) information have higher priority
4. CSI reports may have higher priority based on their type, e.g., whether the CSI report is aperiodic, semi-persistent or periodic, and whether the report is sent via PUSCH or PUCCH, may impact the priority of the CSI report

TABLE 1
Priority Reporting Levels for Part 2 CSI

Priority 0:
For CSI reports 1 to N_{Rep}, Group 0 CSI for CSI
reports configured as ‘typeII-r16’ or ‘typeII-
PortSelection-r16’; Part 2 wideband CSI for CSI
reports configured otherwise
Priority 1:
Group 1 CSI for CSI report 1, if configured as
‘typeII-r16’ or ‘typeII-PortSelection-r16’; Part 2
subband CSI of even subbands for CSI report 1, if
configured otherwise
Priority 2:
Group 2 CSI for CSI report 1, if configured as
typeII-r16’ or ‘typeII-PortSelection-r16’; Part 2
subband CSI of odd subbands for CSI report 1, if
configured otherwise
Priority 3:
Group 1 CSI for CSI report 2, if configured as
‘typeII-r16’ or ‘typeII-PortSelection-r16’; Part 2
subband CSI of even subbands for CSI report 2, if
configured otherwise
Priority 4:
Group 2 CSI for CSI report 2, if configured as
‘typeII-r16’ or ‘typeII-PortSelection-r16’. Part 2
subband CSI of odd subbands for CSI report 2, if
configured otherwise
.
.
.
Priority 2N_{Rep} − 1:
Group 1 CSI for CSI report N_{Rep}, if configured as
‘typeII-r16’ or ‘typeII-PortSelection-r16’; Part 2
subband CSI of even subbands for CSI report N_{Rep},
if configured otherwise
Priority 2N_{Rep}:
Group 2 CSI for CSI report N_{Rep}, if configured as
‘typeII-r16’ or ‘typeII-PortSelection-r16’; Part 2
subband CSI of odd subbands for CSI report N_{Rep},
if configured otherwise

Accordingly, CSI reports may be prioritized as follows, where CSI reports with lower identifiers (IDs) have higher priority

Pri_{iCSI}(y,k,c,s)=2·N_{cells}·Mₛ·y+N_{cells}·Mₛ·k+Mₛ·c+s
s: CSI reporting configuration index, and Mₛ: Maximum number of CSI reporting configurations
c: Cell index, and N_{cells}: Number of serving cells
k: 0 for CSI reports carrying L1-RSRP or L1—Signal-to-Interference-and-Noise Ratio (SINR), 1 otherwise
y: 0 for aperiodic reports, 1 for semi-persistent reports on PUSCH, 2 for semi-persistent reports on PUCCH, 3 for periodic reports.

In some scenarios, for triggering aperiodic CSI reporting on PUSCH, a UE can report CSI information for the network using the CSI framework in NR Release 15. The triggering mechanism between a report setting and a resource setting can be summarized in Table 2 below.

TABLE 2
Triggering mechanism between a report
setting and a resource setting

| | | Periodic CSI | SP CSI | AP CSI |
|---|---|---|---|---|
| | | reporting | reporting | Reporting |
| Time Domain | Periodic | RRC | MAC control | DCI |
| Behaviour | CSI-RS | configured | element (CE) | |
| of Resource | | | (PUCCH) | |
| Setting | | | DCI (PUSCH) | |
| | SP CSI-RS | Not | MAC CE | DCI |
| | | Supported | (PUCCH) | |
| | | | DCI (PUSCH) | |
| | AP CSI-RS | Not | Not Supported | DCI |
| | | Supported | | |

Further, in some scenarios:
Associated Resource Settings for a CSI Report Setting have same time domain behavior.
Periodic CSI-RS/Interference Management (IM) resource and CSI reports can be assumed to be present and active once configured by RRC
Aperiodic and semi-persistent CSI-RS/IM resources and CSI reports can be explicitly triggered or activated.
For aperiodic CSI-RS/IM resources and aperiodic CSI reports, the triggering can be done jointly by transmitting a DCI Format 0-1.
Semi-persistent CSI-RS/IM resources and semi-persistent CSI reports can be independently activated.

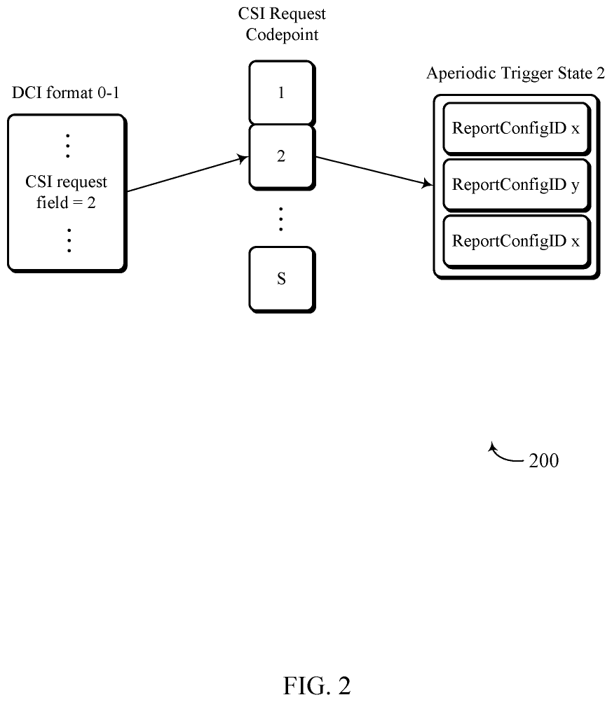

FIG. 2 illustrates an aperiodic trigger state 200 defining a list of CSI report settings. For instance, for aperiodic CSI-RS/IM resources and aperiodic CSI reports, the triggering is done jointly by transmitting a DCI Format 0-1. The DCI Format 0_1 contains a CSI request field (0 to 6 bits). A non-zero request field points to a so-called aperiodic trigger state configured by RRC, such as illustrated in FIG. 2. An aperiodic trigger state in turn is defined as a list of up to 16 aperiodic CSI Report Settings, identified by a CSI Report Setting identifier (ID) for which the UE calculates simultaneously CSI and transmits it on the scheduled PUSCH transmission.

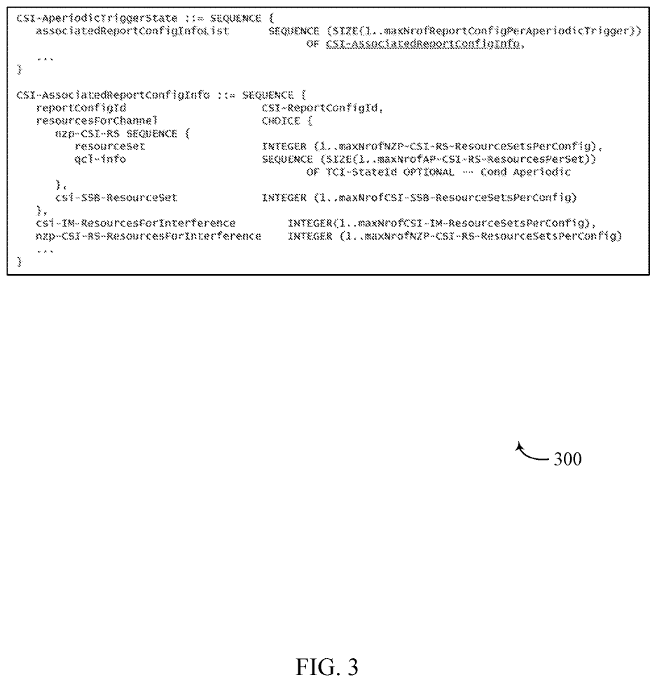

FIG. 3 illustrates an information element 300 pertaining to CSI reporting. The aperiodic trigger state indicates the resource set and QCL information. For instance, when the CSI Report Setting is linked with aperiodic Resource Setting (e.g., including multiple Resource Sets), the aperiodic non-zero power (NZP) CSI-RS Resource Set for channel measurement, the aperiodic CSI-IM Resource Set (if used) and the aperiodic NZP CSI-RS Resource Set for IM (if used) to use for a given CSI Report Setting are also included in the aperiodic trigger state definition. For aperiodic NZP CSI-RS, the quasi co-located (QCL) source to use is also configured in the aperiodic trigger state. The UE considers that the resources used for the computation of the channel and interference can be processed with the same spatial filter e.g. quasi-co-located with respect to “QCL-TypeD.”

FIG. 4 illustrates an information element 400 for RRC configuration for wireless resources. The information element 400, for instance, can configure NZP-CSI-RS/CSI-IM resources. The information element 400, for instance, illustrates RRC configuration (a) for NZP-CSI-RS Resource and (b) for CSI-IM-Resource.

Table 3 summarizes the type of uplink channels used for CSI reporting as a function of the CSI codebook type.

TABLE 3
Uplink channels used for CSI reporting
as a function of the CSI codebook type

| | Periodic CSI | SP CSI | AP CSI |
|---|---|---|---|
| | reporting | reporting | reporting |
| Type I WB | PUCCH | PUCCH Format 2 | PUSCH |
| | Format 2, 3, 4 | PUSCH | |
| Type I SB | | PUCCH Format 3, 4 | PUSCH |
| | | PUSCH | |
| Type II WB | | PUCCH Format 3, 4 | PUSCH |
| | | PUSCH | |
| Type II SB | | PUSCH | PUSCH |
| Type II Part 1 only | | PUCCH Format 3, 4 | |

For aperiodic CSI reporting, PUSCH-based reports are divided into two CSI parts: CSI Part1 and CSI Part 2. The reason for this is that the size of CSI payload varies significantly, and therefore a worst-case UCI payload size design would result in large overhead.

CSI Part 1 has a fixed payload size (and can be decoded by the gNB without prior information) and contains the following:
RI (if reported), CSI-RS Resource Index (CRI) (if reported) and CQI for the first codeword,
number of non-zero wideband amplitude coefficients per layer for Type II CSI feedback on PUSCH.

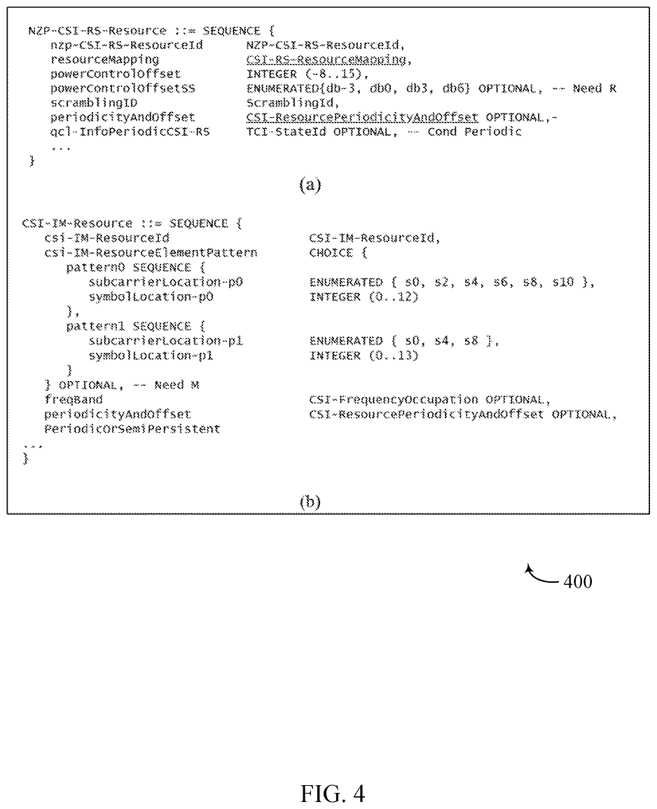

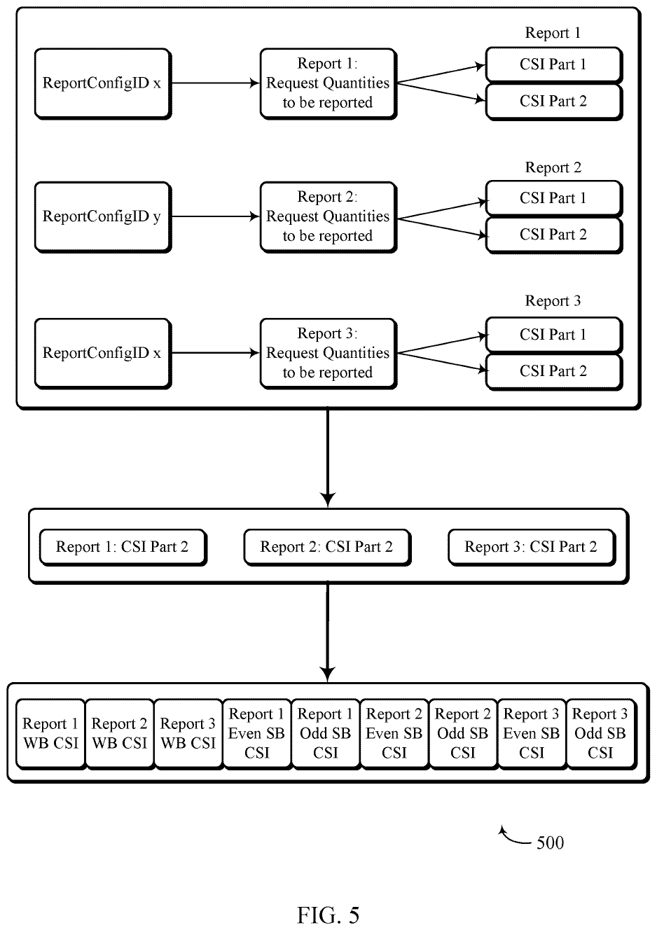

FIG. 5 illustrates a scenario 500 for partial CSI omission for PUSCH-based CSI. The scenario 500, for example, illustrates reordering of CSI Part 2 across CSI reports. CSI Part 2 can have a variable payload size that can be derived from the CSI parameters in CSI Part 1 and contains PMI and the CQI for the second codeword when RI>4. For example, if the aperiodic trigger state indicated by DCI format 0_1 defines 3 report settings x, y, and z, then the aperiodic CSI reporting for CSI part 2 can be ordered as illustrated in the scenario 500.

As mentioned above, CSI reports can be prioritized according to:
1. time-domain behavior and physical channel, where more dynamic reports are given precedence over less dynamic reports and PUSCH has precedence over PUCCH.
2. CSI content, where beam reports (e.g., L1-RSRP reporting) has priority over regular CSI reports.
3. the serving cell to which the CSI corresponds (in case of carrier aggregation (CA) operation). CSI corresponding to the PCell has priority over CSI corresponding to Scells.
4. the reportConfigID.

A CSI report may include a CQI report quantity corresponding to channel quality assuming a maximum target transport block error rates, which indicates a modulation order, a code rate and a corresponding spectral efficiency associated with the modulation order and code rate pair. Examples of the maximum transport block error rates are 0.1 and 0.00001. The modulation order can vary from Quadrature Phase Shift Keying (QPSK) up to 1024QAM, whereas the code rate may vary from 30/1024 up to 948/1024. One example of a CQI table for a 4-bit CQI indicator that identifies a possible CQI value with the corresponding modulation order, code rate and efficiency is provided in Table 4, as follows

TABLE 4
Example of a 4-bit CQI table

| | | | |
|---|---|---|---|
| CQI | | | |
| index | modulation | code rate × 1024 | efficiency |

| | |
|---|---|
| 0 | out of range |

| | | | |
|---|---|---|---|
| 1 | QPSK | 78 | 0.1523 |
| 2 | QPSK | 120 | 0.2344 |
| 3 | QPSK | 193 | 0.3770 |
| 4 | QPSK | 308 | 0.6016 |
| 5 | QPSK | 449 | 0.8770 |
| 6 | QPSK | 602 | 1.1758 |
| 7 | 16QAM | 378 | 1.4766 |
| 8 | 16QAM | 490 | 1.9141 |
| 9 | 16QAM | 616 | 2.4063 |
| 10 | 64QAM | 466 | 2.7305 |
| 11 | 64QAM | 567 | 3.3223 |
| 12 | 64QAM | 666 | 3.9023 |
| 13 | 64QAM | 772 | 4.5234 |
| 14 | 64QAM | 873 | 5.1152 |
| 15 | 64QAM | 948 | 5.5547 |

A CQI value may be reported in two formats: a wideband format, wherein one CQI value is reported corresponding to each PDSCH transport block, and a subband format, wherein one wideband CQI value is reported for the entire transport block, in addition to a set of subband CQI values corresponding to CQI subbands on which the transport block is transmitted. CQI subband sizes are configurable, and depends on the number of PRBs in a bandwidth part, as shown in Table 5, as follows:

TABLE 5
Configurable subband sizes for a given bandwidth part (BWP) size

| Bandwidth part (PRBs) | Subband size (PRBs) |
|---|---|
| 24-72 | 4, 8 |
| 73-144 | 8, 16 |
| 145-275 | 16, 32 |

If the higher layer parameter cqi-BitsPerSubband in a CSI reporting setting CSI-ReportConfig is configured, subband CQI values are reported in a full form, e.g., using 4 bits for each subband CQI based on a CQI table, e.g., Table 4. If the higher layer parameter cqi-BitsPerSubband in CSI-ReportConfig is not configured, for each subband s, a 2-bit sub-band differential CQI value is reported, defined as:
Sub-band Offset level (s)=sub-band CQI index (s)—wideband CQI index.

The mapping from the 2-bit sub-band differential CQI values to the offset level is shown in Table 6, as follows:

TABLE 6
Mapping subband differential CQI value to offset level

| Sub-band differential | |
|---|---|
| CQI value | Offset level |
| 0 | 0 |
| 1 | 1 |
| 2 | ≥2 |
| 3 | ≤−1 |

For AI/ML-based CSI frameworks, multiple alternatives exist for the outline of the AIL/L algorithm functionality, such as:
1. The AI/ML model is trained at the UE node. This alternative may appear reasonable since the UE is the node that can seamlessly collect training data for CSI acquisition using DL pilot signals, e.g., CSI-RSs for channel measurement, however, the AI/ML model should be re-trained whenever the environment changes, e.g., change of the UE location or orientation and every training instance requires significant memory and computational complexity requirements.
2. The AI/ML model is trained at the network node. One advantage of this approach is that the network has significantly more power and computational capabilities compared with a UE node, and hence can manage training moderately complex AI/ML models, as well as store large amounts of training data. Moreover, since a network node is mostly assumed to be fixed, its coverage area is expected to be the same and hence a single AI/ML model can be applicable to UEs within a specific region of the cell for a reasonable period of time. The one challenge with this approach is related to obtaining the training data at the network node, especially for FDD systems in which the UL/DL channel reciprocity may not hold. Note that the overhead corresponding to feeding back the training data from the UE to the network should be considered as one of the metrics when assessing the efficiency of an AI/MIL algorithm.

In the sequel, it can be assumed the AI/ML, model is trained at the network due to the advantages corresponding to memory, computation, and cell-centric characteristics of the network-based AI/ML model computation. The challenge corresponding to obtaining the training data corresponding to the DL channel at the network side is discussed in the next section.

Assuming the AI/ML model is trained at the network, a few aspects are discussed for DL training data acquisition at the network side to enable efficient AI/ML modeling.
1. In order to maintain the robustness of the AI/ML, model with respect to channel variations, DL training data should be continuously fed back to the network to keep up with changes in the environment, e.g., traffic, weather, and mobile scatterers. Note that this may not necessarily correspond to online learning; even for an offline learning algorithm a framework for obtaining new training data corresponding to channel variations should be characterized.
2. Based on the current codebook-based DL CSI feedback schemes in NR, the CSI is compressed in at least one of the spatial domain, or the frequency domain, or both. One intuitive approach would be using the codebook-based CSI feedback, e.g., Type-I and/or Type-II codebooks for obtaining the training data. One disadvantage of this approach is that the training data would include CSI feedback that is already compressed via conventional approaches, which would have detrimental effect on the AI/MIL model inference accuracy. For instance, if the AI/ML model compares the output of the AI/MIL model with the channel corresponding to the CSI feedback to assess its own inference accuracy, this assessment would not be precise since it is based on H′, an estimate of the channel based on a predefined compression, rather than H, a digitally quantized channel without further compression in spatial domain, or frequency domain. On the other hand, if the UE feeds back the training data corresponding to the DL CSI feedback without compression over spatial and/or frequency dimensions, the feedback overhead of the training data would be significant, which would beat the purpose of using the AI/ML model, which is mainly to reduce the overall CSI feedback overhead. Numerically, an AI/MIL-based CSI feedback aims at minimizing the following metric:

$${min}_{\hat{H}} ‖ \hat{H} - H ‖$$

Wherein H represents a digital-domain representation of the channel matrix. On the other hand, a compressed channel H′, which represents the recovered channel after codebook-based transformation, would yield the following optimization metric

$${min}_{\hat{H}} ‖ \hat{H} - {H}^{′} ‖$$

Since H≠H′, the output of both optimizations may yield different channel estimates.

For DL CSI acquisition in NR, whether the network operates in FDD mode or Time-Division Duplexing (TDD) mode, it is unlikely that AI/ML would fully replace RS-based CSI feedback for high-resolution precoding design, since some channel parameters may vary from one time instant to another, without strong correlation across the two time instants, e.g., initial random phases of the channel. Given that, AI/ML-based CSI framework can be envisioned as means of further reducing the CSI feedback overhead compared with conventional methods, e.g., reduce the number of dominant spatial-domain basis indices, frequency/delay-domain basis indices, and time/Doppler-domain basis indices, after spatial domain transformation, frequency-domain transformation, and time-domain transformation, respectively. While current CSI feedback frameworks already provide CSI feedback overhead reduction via exploiting such transformations, the CSI dimensionality can be further reduced if a wider range of transformation techniques are pre-configured, wherein a different transformation may be selected for a given UE based on variations of the channel.

In some wireless communications systems, the terms antenna, panel, and antenna panel are used interchangeably. An antenna panel may be a hardware that is used for transmitting and/or receiving radio signals at frequencies lower than 6 GHz, e.g., frequency range 1 (FR1), or higher than 6 GHz, e.g., frequency range 2 (FR2) or millimeter wave (mmWave). In some implementations, an antenna panel may include an array of antenna elements, wherein each antenna element is connected to hardware such as a phase shifter that allows a control module to apply spatial parameters for transmission and/or reception of signals. The resulting radiation pattern may be called a beam, which may or may not be unimodal and may allow the device to amplify signals that are transmitted or received from spatial directions.

In some scenarios, an antenna panel may or may not be virtualized as an antenna port in the specifications. An antenna panel may be connected to a baseband processing module through a radio frequency (RF) chain for each of transmission (egress) and reception (ingress) directions. A capability of a device in terms of the number of antenna panels, their duplexing capabilities, their beamforming capabilities, and so on, may or may not be transparent to other devices. In some implementations, capability information may be communicated via signaling or, in some implementations, capability information may be provided to devices without a need for signaling. In the case that such information is available to other devices, it can be used for signaling or local decision making.

In some scenarios, a device (e.g., UE, node) antenna panel may be a physical or logical antenna array including a set of antenna elements or antenna ports that share a common or a significant portion of an RF chain (e.g., in-phase/quadrature (I/Q) modulator, analog to digital (A/D) converter, local oscillator, phase shift network). The device antenna panel or “device panel” may be a logical entity with physical device antennas mapped to the logical entity. The mapping of physical device antennas to the logical entity may be up to device implementation. Communicating (receiving or transmitting) on at least a subset of antenna elements or antenna ports active for radiating energy (also referred to herein as active elements) of an antenna panel requires biasing or powering on of the RF chain which results in current drain or power consumption in the device associated with the antenna panel (including power amplifier/low noise amplifier (LNA) power consumption associated with the antenna elements or antenna ports). The phrase “active for radiating energy,” as used herein, is not meant to be limited to a transmit function but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In some scenarios, depending on device's own implementation, a “device panel” can have at least one of the following functionalities as an operational role of Unit of antenna group to control its Tx beam independently, Unit of antenna group to control its transmission power independently, Unit of antenna group to control its transmission timing independently. The “device panel” may be transparent to gNB. For certain condition(s), gNB or network can assume the mapping between device's physical antennas to the logical entity “device panel” may not be changed. For example, the condition may include until the next update or report from device or include a duration of time over which the gNB assumes there will be no change to the mapping. A Device may report its capability with respect to the “device panel” to the gNB or network. The device capability may include at least the number of “device panels”. In one implementation, the device may support UL transmission from one beam within a panel; with multiple panels, more than one beam (one beam per panel) may be used for UL transmission. In another implementation, more than one beam per panel may be supported/used for UL transmission.

In some scenarios, an antenna port is defined such that the channel over which a symbol on the antenna port is conveyed can be inferred from the channel over which another symbol on the same antenna port is conveyed.

Two antenna ports are said to be QCL if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters. Two antenna ports may be quasi-located with respect to a subset of the large-scale properties and different subset of large-scale properties may be indicated by a QCL Type. The QCL Type can indicate which channel properties are the same between the two reference signals (e.g., on the two antenna ports). Thus, the reference signals can be linked to each other with respect to what the UE can assume about their channel statistics or QCL properties. For example, qcl-Type may take one of the following values:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}.

Spatial Rx parameters may include one or more of: angle of arrival (AoA) Dominant AoA, average AoA, angular spread, Power Angular Spectrum (PAS) of AoA, average AoD (angle of departure), PAS of AoD, transmit/receive channel correlation, transmit/receive beamforming, spatial channel correlation etc.

The QCL-TypeA, QCL-TypeB and QCL-TypeC may be applicable for all carrier frequencies, but the QCL-TypeD may be applicable only in higher carrier frequencies (e.g., mmWave, FR2 and beyond), where essentially the UE may not be able to perform omni-directional transmission, e.g. the UE would need to form beams for directional transmission. A QCL-TypeD between two reference signals A and B, the reference signal A is considered to be spatially co-located with reference signal B and the UE may assume that the reference signals A and B can be received with the same spatial filter (e.g., with the same receive beamforming weights).

An “antenna port” according to an implementation may be a logical port that may correspond to a beam (resulting from beamforming) or may correspond to a physical antenna on a device. In some implementations, a physical antenna may map directly to a single antenna port, in which an antenna port corresponds to an actual physical antenna. Alternately, a set or subset of physical antennas, or antenna set or antenna array or antenna sub-array, may be mapped to one or more antenna ports after applying complex weights, a cyclic delay, or both to the signal on each physical antenna. The physical antenna set may have antennas from a single module or panel or from multiple modules or panels. The weights may be fixed as in an antenna virtualization scheme, such as cyclic delay diversity (CDD). The procedure used to derive antenna ports from physical antennas may be specific to a device implementation and transparent to other devices.

In some scenarios, a TCI-state (Transmission Configuration Indication) associated with a target transmission can indicate parameters for configuring a quasi-collocation relationship between the target transmission (e.g., target RS of demodulation (DM)-RS ports of the target transmission during a transmission occasion) and a source reference signal(s) (e.g., Synchronization Signal Block (SSB)/CSI-RS/Sounding Reference Signal (SRS)) with respect to quasi co-location type parameter(s) indicated in the corresponding TCI state. The TCI describes which reference signals are used as QCL source, and what QCL properties can be derived from each reference signal. A device can receive a configuration of a plurality of transmission configuration indicator states for a serving cell for transmissions on the serving cell. In some of the implementations described, a TCI state includes at least one source RS to provide a reference (UE assumption) for determining QCL and/or spatial filter.

In some scenarios, a spatial relation information associated with a target transmission can indicate parameters for configuring a spatial setting between the target transmission and a reference RS (e.g., SSB/CSI-RS/SRS). For example, the device may transmit the target transmission with the same spatial domain filter used for reception the reference RS (e.g., DL RS such as SSB/CSI-RS). In another example, the device may transmit the target transmission with the same spatial domain transmission filter used for the transmission of the reference RS (e.g., UL RS such as SRS). A device can receive a configuration of a plurality of spatial relation information configurations for a serving cell for transmissions on the serving cell.

In some scenarios, a UL TCI state is provided if a device is configured with separate DL/UL TCI by RRC signaling. The UL TCI state may include a source reference signal which provides a reference for determining UL spatial domain transmission filter for the UL transmission (e.g., dynamic-grant/configured-grant based PUSCH, dedicated PUCCH resources) in a component carrier (CC) or across a set of configured CCs/BWPs.

In some scenarios, a joint DL/UL TCI state is provided if the device is configured with joint DL/UL TCI by RRC signaling (e.g., configuration of joint TCI or separate DL/UL TCI is based on RRC signaling). The joint DL/UL TCI state refers to at least a common source reference RS used for determining both the DL QCL information and the UL spatial transmission filter. The source RS determined from the indicated joint (or common) TCI state provides QCL Type-D indication (e.g., for device-dedicated Physical Downlink Control Channel/Physical Downlink Shared Channel (PDCCH/PDSCH) and is used to determine UL spatial transmission filter (e.g., for UE-dedicated PUSCH/PUCCH) for a CC or across a set of configured CCs/BWPs. In one example, the UL spatial transmission filter is derived from the RS of DL QCL Type D in the joint TCI state. The spatial setting of the UL transmission may be according to the spatial relation with a reference to the source RS configured with qcl-Type set to ‘typeD’ in the joint TCI state.

In implementations, consider that a channel between a UE and a gNB with P channel paths (index p=0, . . . , P−1) occupies N_{SB} frequency bands (index n=0, . . . , N_{SB}−1), wherein the gNB is equipped with K antennas (index k=0, . . . , K−1). The channel at a time index δ can then be represented as follows

$${h}_{k , n} ( δ ) = {\sum }_{p = 0}^{P - 1} {g}_{k , p} {e}^{j 2 π n Δ f {τ}_{p} + j 2 πk \frac{{F}_{c} d}{c} sin {θ}_{p} + j 2 π δ \frac{{F}_{c} v}{c} cos {ϕ}_{p}}$$

g_{k,p}: Complex gain of path p at antenna k
Δf: PMI Sub-band spacing
τₚ: Delay of path p
F_{c}: Carrier Frequency
c: Speed of light
d: Antenna spacing at gNB
θₚ: angular spatial displacement at the gNB antenna array corresponding to path p
δ: Time index
v: Relative speed between gNB & UE
Φₚ: Angle between the moving direction & the signal incidence direction of path p

In implementations the channel above can be parametrized by three dimensions: frequency, spatial, and temporal dimensions. In order to construct a precoder codebook with reasonable CSI feedback overhead, the CSI corresponding to the three dimensions can be compressed. In Rel. 16 eType-II codebook, both spatial and frequency domains can be compressed via DFT transformation of the spatial and frequency domains with columns of two-dimensional and one-dimensional DFT matrices, respectively, whereas in potential Rel-18 eType-II codebook for high speed, the time domain can be further compressed via DFT transformation in the form of columns of a one-dimensional DFT matrix. Additionally or alternatively, CSI feedback may be transmitted in an explicit format, e.g., in terms of explicit channel coefficients, so as to enhance the CSI feedback resolution. However, the CSI feedback overhead would increase significantly, especially for scenarios training dataset transmission, in which the CSI feedback comprises a large number of training dataset points corresponding to different realizations of the CSI. An AI-based CSI framework is discussed in which statistical CSI training data is reported via aggregating similar training dataset points corresponding to CSI, where a corresponding weight or rate of occurrence of this dataset point is fed back as part of the CSI feedback corresponding to the training data. Moreover, likelihood ratios of whether a given coefficient corresponding to a channel or precoding matrix is associated with a non-zero amplitude value are reported, wherein the likelihood ratios are based on the weight or rate of occurrence of a given CSI datapoint as part of the training dataset point. Furthermore, the aforementioned AI-based CSI framework helps infer the characteristics of the channel distribution based on the training dataset, such that CSI feedback can utilize distribution-aware data compression schemes, e.g., Huffman coding, where CSI parameters are encoded such that values with higher likelihood of occurrence are mapped to a shorter sequence of bits, whereas CSI parameters are encoded such that values with lower likelihood of occurrence are mapped to a longer sequence of bits.

An indication of CSI training dataset transmission can be transmitted. In one or more implementations, the CSI training dataset report is transmitted from a network node (e.g., a network entity such as a gNB) to the UE. In one example, the CSI training dataset report is transmitted over a PDSCH. In another example, the CSI training dataset report is transmitted over a PDCCH. In another example, the CSI training dataset report is transmitted via higher-layer signaling, e.g., as part of an RRC configuration.

Additionally or alternatively, the CSI training dataset is transmitted from the UE to a network node (e.g., a network entity such as a gNB). In one example, the CSI training dataset report is transmitted over a PUSCH. In another example, the CSI training dataset report is transmitted over a PUCCH. In another example, the CSI training dataset report is further divided into two parts, a first part of the two parts of the CSI training dataset report is transmitted over the PUCCH, and a second part of the two parts of the CSI training dataset report is transmitted over the PUSCH.

Additionally or alternatively, the CSI training dataset report corresponds to a CSI report type that is configured via a CSI reporting setting. In one example, the CSI reporting setting comprises a higher-layer configuration parameter, where the higher-layer configuration parameter is set to true if the CSI report corresponds to a CSI training dataset report. In another example, the CSI training dataset reports corresponds to a new codebook type of a CSI report corresponding to a PMI, e.g., the CSI training dataset report corresponds to a Type-III codebook type.

Additionally or alternatively, the CSI training dataset report is configured via a dedicated higher-layer reporting setting, e.g., training data reporting setting or AI reporting setting.

Type-II high resolution CSI compression can be performed. In one or more implementations, the CSI feedback corresponding to the CSI training dataset report is based on a Rel-18 Type-II codebook format, where parameters corresponding to W₁, \tilde{W}_{2,l}, W_{f,l}, W_{d,l}, or the bitmap corresponding to the LCCs of \tilde{W}_{2,l} are reported as part of the training dataset-based CSI report. In one example, the matrix W_{d,l} is trivialized to a scalar value of one, e.g., the codebook format resembles that of a Rel-16 Type-II codebook.

Additionally or alternatively, a configured value of a parameter corresponding to a number of beams, e.g., L, for a CSI training dataset report is larger than the value L corresponding to a Type-II codebook-based CSI report, e.g., L=6,8,10 under a CSI training dataset report.

Additionally or alternatively, a configured value of a parameter corresponding to a number of frequency-domain basis indices, e.g., M, for a CSI training dataset report is larger than the value M corresponding to a Type-II codebook-based CSI report, e.g., M=0.5N₃, 0.75N₃, or N₃ under a CSI training dataset report.

Additionally or alternatively, a configured value of a parameter corresponding to a number of time-domain basis indices, e.g., Q, for a CSI training dataset report is larger than the value Q corresponding to a Type-II codebook-based CSI report, e.g., Q=N₄ under a CSI training dataset report.

Additionally or alternatively, a configured value of a parameter corresponding to a fraction of non-zero coefficients, e.g., β, for a CSI training dataset report is larger than the value β corresponding to a Type-II codebook-based CSI report, e.g., β=1 under a CSI training dataset report.

Additionally or alternatively, an indication of a total number of dataset points included in the CSI training dataset report is reported as part of the CSI training dataset report.

Additionally or alternatively, an indication of a total number of bits corresponding to a size of the CSI training dataset report is reported in a first part of the CSI training dataset report, where the CSI training dataset report comprises multiple parts.

Reporting weights of CSI/PMI compression matrices can also be performed. In a CSI training dataset report, a compression or transformation of spatial, frequency, or time domain basis indices may be applied. Different implementations are provided below. One or more of these implementations may also be combined.

In one or more implementations, the CSI training dataset report comprises a selection corresponding to a subset of the set of possible spatial-domain basis combinations, e.g., beam combinations. In one example, the subset comprises N′ spatial-domain basis combinations of a set of

$${C}_{L}^{{N}_{1} {N}_{2}}$$

spatial-domain basis combinations. In another example, the selected subset of the spatial-domain basis combinations is indicated via N′ parameters with a bitwidth of

$$⌈ {log}_{2} {C}_{L}^{{N}_{1} {N}_{2}} ⌉$$

bits each, wherein [x] corresponds to a ceiling operator, e.g., the smallest integer value that is greater than or equal to a parameter x. In another example, the N′ selected subset of the spatial-domain basis combinations are jointly indicated via a single parameter with a bitwidth of

$$⌈ {N}^{′} \cdot {log}_{2} {C}_{L}^{{N}_{1} {N}_{2}} ⌉$$

bits.

Additionally or alternatively, the CSI training dataset report comprises a selection corresponding to a subset of the set of possible frequency-domain basis combinations. In one example, the subset comprises N′ frequency-domain basis combinations of a set of

$${C}_{M}^{{N}_{3}}$$

frequency-domain basis combinations. In another example, the selected subset of the frequency-domain basis combinations is indicated via N′ parameters with a bitwidth of

$$⌈ {log}_{2} {C}_{M}^{{N}_{3}} ⌉$$

bits each. In another example, the N′ selected subset of the frequency-domain basis combinations are jointly indicated via a single parameter with a bitwidth of

$$⌈ {N}^{′} \cdot {log}_{2} {C}_{M}^{{N}_{3}} ⌉$$

bits.

Additionally or alternatively, the CSI training dataset report comprises a selection corresponding to a subset of the set of possible time-domain basis combinations. In one example, the subset comprises N′ time-domain basis combinations of a set of

$${C}_{Q}^{{N}_{4}}$$

time-domain basis combinations. In another example, the selected subset of the time-domain basis combinations is indicated via N′ parameters with a bitwidth of

$$⌈ {log}_{2} {C}_{Q}^{{N}_{4}} ⌉$$

bits each. In another example, the N′ selected subset of the time-domain basis combinations are jointly indicated via a single parameter with a bitwidth of

$$⌈ {N}^{′} . {log}_{2} {C}_{Q}^{{N}_{4}} ⌉$$

bits

Additionally or alternatively, the CSI training dataset report comprises a selection corresponding to a subset of the set of possible joint spatial/frequency-domain bases combinations. In one example, the subset comprises N′ joint spatial/frequency-domain bases combinations of a set of

$${C}_{L M}^{{N}_{1} {N}_{2} {N}_{3}}$$

joint spatial/frequency-domain bases combinations. In another example, the selected subset of the joint spatial/frequency-domain bases combinations is indicated via N′ parameters with a bitwidth of

$$⌈ {log}_{2} {C}_{L M}^{{N}_{1} {N}_{2} {N}_{3}} ⌉$$

bits each. In another example, the N′ selected subset of the joint spatial/frequency-domain bases combinations are jointly indicated via a single parameter with a bitwidth of

$$⌈ {N}^{′} . {log}_{2} {C}_{L M}^{{N}_{1} {N}_{2} {N}_{3}} ⌉$$

bits.

Additionally or alternatively, the CSI training dataset report comprises a selection corresponding to a subset of the set of possible joint frequency/time-domain bases combinations. In one example, the subset comprises N′ joint frequency/time-domain bases combinations of a set of

$${C}_{M Q}^{{N}_{3} {N}_{4}}$$

joint frequency/time-domain bases combinations. In another example, the selected subset of the joint frequency/time-domain bases combinations is indicated via N′ parameters with a bitwidth of

$$⌈ {log}_{2} {C}_{M Q}^{{N}_{3} {N}_{4}} ⌉$$

bits each. In another example, the N′ selected subset of the joint frequency/time-domain bases combinations are jointly indicated via a single parameter with a bitwidth of

$$⌈ {N}^{′} . {log}_{2} {C}_{M Q}^{{N}_{3} {N}_{4}} ⌉$$

bits.

Additionally or alternatively, the CSI training dataset report comprises a selection corresponding to a subset of the set of possible joint spatial/time-domain bases combinations. In one example, the subset comprises N′ joint spatial/time-domain bases combinations of a set of

$${C}_{L Q}^{{N}_{1} {N}_{2} {N}_{4}}$$

joint spatial/time-domain bases combinations. In another example, the selected subset of the joint spatial/time-domain bases combinations is indicated via N′ parameters with a bitwidth of

$$⌈ {log}_{2} {C}_{L Q}^{{N}_{1} {N}_{2} {N}_{4}} ⌉$$

bits each. In another example, the N′ selected subset of the joint spatial/time-domain bases combinations are jointly indicated via a single parameter with a bitwidth of

$$⌈ {N}^{′} . {log}_{2} {C}_{L Q}^{{N}_{1} {N}_{2} {N}_{4}} ⌉$$

bits.

Additionally or alternatively, the CSI training dataset report comprises a selection corresponding to a subset of the set of possible joint spatial/frequency/time-domain bases combinations. In another example, the subset comprises N′ joint spatial/frequency/time-domain bases combinations of a set of

$${C}_{LMQ}^{{N}_{1} {N}_{2} {N}_{3} {N}_{4}}$$

joint spatial/frequency/time-domain bases combinations. In another example, the selected subset of the joint spatial/frequency/time-domain bases combinations is indicated via N′ parameters with a bitwidth of

$$⌈ {log}_{2} {C}_{L M Q}^{{N}_{1} {N}_{2} {N}_{3} {N}_{4}} ⌉$$

bits each. In another example, the N′ selected subset of the joint spatial/frequency/time-domain bases combinations are jointly indicated via a single parameter with a bitwidth of

$$⌈ {N}^{′} . {log}_{2} {C}_{L M Q}^{{N}_{1} {N}_{2} {N}_{3} {N}_{4}} ⌉$$

bits.

Additionally or alternatively, the CSI training dataset report comprises a weight or probability corresponding to each of the N′ sized subset of the basis/bases combinations. In one example, N′ parameters are fed back, each parameter corresponding to a weight of each of the N′ selected combinations. In another example, each weight parameter value is selected from a predefined or pre-configured codebook of weight values. In another example, the weights are normalized by the size of the dataset. In another example, the weights are normalized by a value of the largest weight, e.g., at least one weight is set to one.

Bitmap reporting for training data can also be performed. In a CSI training dataset report, only a subset of coefficient values may be associated with a non-zero amplitude value. Different implementations are provided below. One or more of these implementations may also be combined.

In one or more implementations, an indication of the non-zero coefficients corresponding to the coefficients' matrix \tilde{W}_{2,l} is reported in the CSI training dataset report.

Additionally or alternatively, a plurality of K′ bitmaps are reported in the CSI training dataset report. In one example, a distinct set of K′ bitmaps are reported for each combination of the N′ selected basis/bases combinations. In another example, a common set of K′ bitmaps are reported for all the N′ selected basis/bases combinations.

Additionally or alternatively, a set of parameters with a one-to-one mapping corresponding to the coefficients of the precoding matrix are reported in the CSI training dataset report, wherein each parameter of the set of parameters comprises an indication of a likelihood of whether a corresponding coefficient is quantized to a zero-amplitude value. In one example, the indication is in a form of a probability of whether the coefficient is quantized to a zero-amplitude value. An illustration of this example can be found in Table 7 below. This example corresponds to reporting a likelihood of each coefficient of a precoding matrix with L=6, M=10, e.g., \tilde{W}_{2,l} of size 12×10, having a non-zero value.

TABLE 7

| | | | | | | | | | |
|---|---|---|---|---|---|---|---|---|---|
| 1 | 0.5 | 0 | 0 | 0 | 0 | 0 | 0 | 0 | 0.25 |
| 0.25 | 0 | 0 | 0 | 0.25 | 0 | 0 | 0 | 0.25 | 0.75 |
| 0.25 | 0.25 | 0 | 0 | 0 | 0.75 | 0.5 | 0 | 0 | 0.25 |
| 0 | 0 | 0.5 | 0.75 | 0.75 | 0 | 0 | 0.5 | 0.5 | 0.25 |
| 0 | 0 | 0 | 0 | 0 | 0.25 | 0 | 0 | 0 | 0 |
| 0.5 | 0.5 | 0.5 | 0.75 | 0.5 | 0 | 0 | 0 | 0 | 0.5 |
| 0.75 | 1 | 1 | 0.5 | 0 | 0 | 0 | 0.25 | 0.25 | 0.5 |
| 0.25 | 0.5 | 0.25 | 0 | 0 | 0 | 0 | 0.25 | 0.25 | 0.25 |
| 0 | 0.25 | 0.25 | 0 | 0.25 | 0.5 | 0.5 | 0.25 | 0 | 0.25 |
| 0.25 | 0 | 0 | 0.25 | 0.5 | 0.5 | 0.25 | 0 | 0.25 | 0.5 |
| 0 | 0 | 0 | 0 | 0.25 | 0.5 | 0 | 0 | 0.5 | 0.25 |
| 0.75 | 0.5 | 0.25 | 0 | 0 | 0 | 0.25 | 0.75 | 0.5 | 1 |

In another example, the indication is in a form of a function of a likelihood ratio, e.g., LLR based on a ratio of a probability of the coefficient being quantized to a zero-amplitude value, to a probability of the coefficient being quantized to a non-zero-amplitude value.

PMI reporting of amplitude/phase coefficients for training data can be performed. The CSI training dataset report may comprise a number of non-zero coefficients corresponding to the coefficients' matrix \tilde{W}_{2,1} is reported in the CSI training dataset report. For each of the non-zero coefficients, an amplitude value and a phase value may be reported. Different implementations are discussed below. One or more of these implementations may also be combined.

In one or more implementations, multiple of amplitude values, multiple phase values, or a combination thereof, are jointly encoded to a common indicator value of a set of indicator values. In one example, the multiple amplitude values correspond to a subset of coefficients associated with a common spatial-domain basis index, e.g., beam index. In another example, the multiple amplitude values correspond to a subset of coefficients associated with a common frequency-domain basis index, e.g., beam index.

Additionally or alternatively, two distributions, types, or classes of an indication of the amplitude values, the phase values, or a combination thereof, are supported, where the selected distribution, type, or class is based on an index of spatial-domain basis, an index of a frequency-domain basis, an index of time-domain basis, or a combination thereof. In one example, a first distribution, type, or class corresponds to a spatial-domain basis index, e.g., beam index, that is associated with a strongest coefficient, e.g., a coefficient with a largest amplitude value, and a second distribution, type, or class corresponds to all spatial-domain basis indices that are not associated with the strongest coefficient. In another example, a first group comprising multiple sets of amplitude and phase coefficient values are defined according to the first distribution, and a second group comprising multiple sets of amplitude and phase coefficient values are defined according to the first distribution.

Additionally or alternatively, at least one distribution, type, or class of an indication of the amplitude values, the phase values, or a combination thereof, is supported, where the selected distribution, type, or class is based on a layer index corresponding to a number of layers of the precoding matrix. In one example, a same distribution, type, or class is selected for all layers of a precoding matrix. In another example, a distinct distribution, type, or class is selected for each layer of the layers of a precoding matrix.

Additionally or alternatively, the multiple amplitude values, the multiple phase values, or the combination thereof correspond to a set of consecutive basis indices of the spatial domain, the frequency domain or the time domain, where a first basis index of the set of consecutive basis indices is indicated via an offset value that is reported as part of the CSI training dataset report. In one example, the multiple amplitude values correspond to three consecutive amplitude values, as illustrated in Table 8 below.

TABLE 8

| | | |
|---|---|---|
| ½ | 1 | 1/\sqrt{2} |

In another example, an offset value is reported that indicates a location of the first value of the amplitude values is reported, e.g., for a plurality of amplitude values sharing a same spatial-domain basis index with M=9 frequency-domain basis indices, an offset value λ of value 8 (or λ=−1 assuming a circular offset) corresponds to a set of M=9 amplitude values, as shown in Table 9 below.

TABLE 9

| | | | | | | | | |
|---|---|---|---|---|---|---|---|---|
| 1 | 1/\sqrt{2} | 0 | 0 | 0 | 0 | 0 | 0 | 1/2 |

Additionally or alternatively, two classes of amplitude values are reported: a first class of amplitude values corresponding to each coefficient of the set of non-zero coefficients, and a second class of amplitude values corresponding to a common reference values to a group of coefficients of a same polarization value of two polarization values.

RI reporting for training data can be performed. A CSI training dataset report may comprise reference to at least one RI value. Different implementations are discussed below. One or more of these implementations may also be combined.

In one or more implementations, a set of weight or probability values corresponding to a set of RI values is reported in the CSI training dataset report. In one example, the set of weight or probability values correspond to a selected subset of the set of RI values. In another example, the set of weight or probability values are selected from a codebook of weight or probability values. In another example, the set of weight or probability values are reported for all RI values up to a maximum RI value, e.g., given a maximum RI value of 4, the weights corresponding to a set of RI values {1,2,3,4} are provided in Table 10 below.

TABLE 10

| RI | 1 | 2 | 3 | 4 |
|---|---|---|---|---|
| Weight | 0.1 | 0.6 | 0.2 | 0.1 |

CQI reporting for training data can be performed. A CSI training dataset report may comprise reference to at least one CQI value. Different implementations are provided below. One or more of these implementations may also be combined.

In one or more implementations, a set of weight or probability values corresponding to a set of CQI values is reported in the CSI training dataset report. In one example, the set of weight or probability values correspond to a selected subset of the set of CQI values. In a second example, the set of weight or probability values are selected from a codebook of weight or probability values.

Additionally or alternatively, at least one sequence of SB CQI values is indicated via a joint indicator value. In one example, a plurality of indicators are reported, where each indicator corresponds to a plurality of SB CQI values. In another example, a weight or probability value is reported for each indicator of the sequence of SB CQI values.

Additionally or alternatively, a CQI value is associated with one of an RI value, a bitmap, a spatial/frequency/time-domain basis combination, a set of amplitude/phase coefficients, or a combination thereof.

The CSI report can be encoded. Based on the described CSI training dataset report, weights corresponding to spatial/frequency/time-domain basis transformation, bitmap indication, amplitude/phase coefficients, RI, CQI, or a combination thereof, can provide some underlying information corresponding to a precoding matrix/channel distribution. Different implementations are discussed below. One or more of these implementations may also be combined.

In one or more implementations, a CSI report that is computed based on a CSI training dataset report comprises parameters corresponding to at least one of a spatial/frequency/time-domain basis indicator, a bitmap indicator, a set of indicators corresponding to amplitude values of non-zero coefficients, a set of indicators corresponding to phase values of non-zero coefficients, an RI value, a CQI value, or a combination thereof.

Additionally or alternatively, at least one parameter of the CSI report is mapped to a set of values, the set of values are encoded via a coding scheme based on a set of weight or probability values indicated in the training dataset report. In one example, the coding scheme is based on a Huffman coding scheme, where values with a higher weight or probability values are encoded via a smaller number of bits, and values with a lower weight or probability values are encoded via a larger number of bits.

Accordingly, a CSI feedback mechanism that provides a concise framework for training dataset reporting corresponding to CSI feedback is discussed, where the training data is aggregated such that similar training dataset points are fed back once, associated with a weight coefficient corresponding to the probability or rate of occurrence of that dataset point. More specifically reporting statistical CSI training data via aggregating similar training dataset points corresponding to CSI is discussed, where a corresponding weight or rate of occurrence of this dataset point is fed back as part of the CSI feedback corresponding to the training data. Also discussed is reporting likelihood ratios of whether a given coefficient corresponding to a channel/precoding matrix is associated with a non-zero amplitude value, where the likelihood ratios are based on the weight/rate of occurrence of a given CSI datapoint as part of the training dataset point. Also discussed is inferring characteristics of the channel distribution based on the training dataset, such that CSI feedback can utilize distribution-aware data compression schemes, e.g., Huffman coding, where CSI parameters are encoded such that values with higher likelihood of occurrence are mapped to a shorter sequence of bits, whereas CSI parameters are encoded such that values with lower likelihood of occurrence are mapped to a longer sequence of bits.

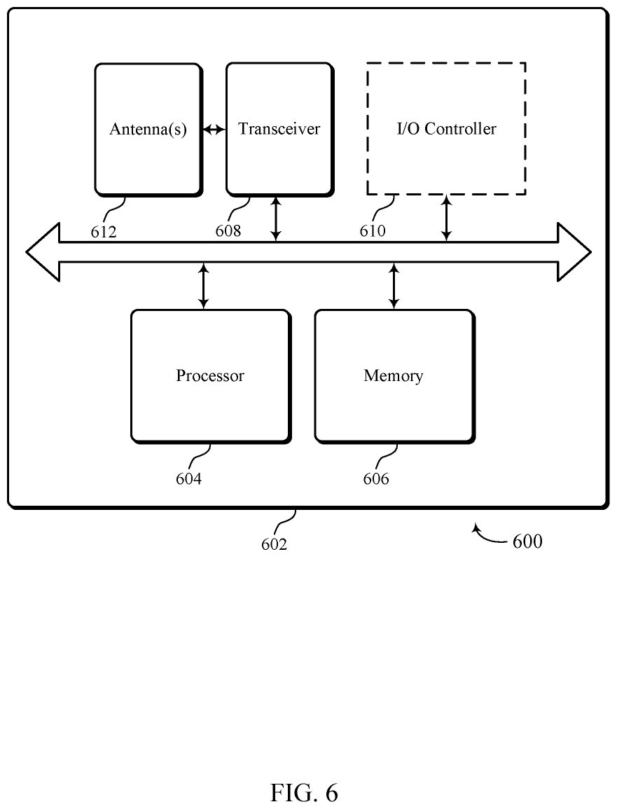

FIG. 6 illustrates an example of a block diagram 600 of a device 602 that supports codebook-based training dataset reports for channel state information in accordance with aspects of the present disclosure. The device 602 may be an example of a UE 104 (or a network entity 102) as described herein. The device 602 may support wireless communication with one or more network entities 102, UEs 104, or any combination thereof. The device 602 may include components for bi-directional communications including components for transmitting and receiving communications, such as a processor 604, a memory 606, a transceiver 608, and an I/O controller 610. These components may be in electronic communication or otherwise coupled (e.g., operatively, communicatively, functionally, electronically, electrically) via one or more interfaces (e.g., buses).

The processor 604, the memory 606, the transceiver 608, or various combinations thereof or various components thereof may be examples of means for performing various aspects of the present disclosure as described herein. For example, the processor 604, the memory 606, the transceiver 608, or various combinations or components thereof may support a method for performing one or more of the operations described herein.

In some implementations, the processor 604, the memory 606, the transceiver 608, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 604 and the memory 606 coupled with the processor 604 may be configured to perform one or more of the functions described herein (e.g., executing, by the processor 604, instructions stored in the memory 606).

For example, the processor 604 may support wireless communication at the device 602 in accordance with examples as disclosed herein. Processor 604 may be configured as or otherwise support to: obtain a training dataset report corresponding to CSI based on a PMI codebook, where the training dataset report includes multiple parameters corresponding to the PMI codebook, the multiple parameters associated with multiple weight values; transmit, to a device, a first signaling indicating the training dataset report.

Additionally or alternatively, the processor 604 may be configured to or otherwise support: where the apparatus comprises a user equipment, and the processor is further configured to cause the apparatus to transmit the first signaling over a physical uplink channel; where the device comprises a user equipment, and the processor is further configured to cause the apparatus to transmit the first signaling over a physical downlink channel, to transmit the first signaling as part of a higher-layer configuration information, or a combination thereof; where the multiple parameters comprise a first set of codepoints and each codepoint of the first set of codepoints corresponds to a selected subset of spatial-domain basis indices, frequency-domain basis indices, time-domain basis indices, or a combination thereof; where the first set of codepoints is a subset of a second set of codepoints, each codepoint of the second set of codepoints corresponding to a subset of spatial-domain basis indices, frequency-domain basis indices, time-domain basis indices, or a combination thereof; where the multiple parameters comprise a set of entries corresponding to a bitmap that identifies reported coefficients with non-zero amplitude values; where each entry of the set of entries corresponds to a likelihood of a coefficient having a non-zero amplitude value; where the multiple parameters comprise a set of codepoints and each codepoint of the set of codepoints corresponds to at least one of a set of coefficient amplitude values and a set of coefficient phase values that are associated with multiple consecutive spatial-domain basis indices, multiple consecutive frequency-domain basis indices, multiple consecutive time-domain basis indices, or a combination thereof; where each codepoint of the set of codepoints is associated with one of two coefficient types, where a first coefficient type of the two coefficient types is associated with a first set of spatial-domain basis indices, frequency-domain basis indices, time-domain basis indices, or a combination thereof, and where a second coefficient type of the two coefficient types is associated with a second set of spatial-domain basis indices, frequency-domain basis indices, time-domain basis indices, or a combination thereof; where the first set of spatial-domain basis indices, frequency-domain basis indices, time-domain basis indices are associated with a strongest coefficient with a largest amplitude value; where the multiple parameters comprise a set of rank indicator values and each rank indicator value of the set of rank indicator values is associated with a distinct weight; where the multiple parameters comprise a set of channel quality indicator values and each channel quality indicator value of the set of channel quality indicator values is associated with a distinct weight; where the processor is further configured to cause the apparatus to: obtain a CSI report that is based on the training dataset report, where the CSI report includes parameters corresponding to spatial-domain basis indices, frequency-domain basis indices, time-domain basis indices, a bitmap indicator, a set of indicators corresponding to amplitude values of non-zero coefficients, a set of indicators corresponding to phase values of non-zero coefficients, a RI value, a CQI value, or a combination thereof, and each of the parameters of the CSI report is mapped to a set of values that are encoded via an encoding scheme based on the multiple weight values included in the training dataset report; and transmit, to the device, a second signaling indicating the CSI report.

For example, the processor 604 may support wireless communication at the device 602 in accordance with examples as disclosed herein. Processor 604 may be configured as or otherwise support a means for obtaining a training dataset report corresponding to CSI based on a PMI codebook, where the training dataset report includes multiple parameters corresponding to the PMI codebook, the multiple parameters associated with multiple weight values; and transmitting, to a device, a first signaling indicating the training dataset report.

Additionally or alternatively, the processor 604 may be configured to or otherwise support: where the method is implemented by a user equipment, and further comprises transmitting the first signaling over a physical uplink channel; where the device comprises a user equipment, and the method further comprises transmitting the first signaling over a physical downlink channel transmitting the first signaling as part of a higher-layer configuration information, or a combination thereof; where the multiple parameters comprise a first set of codepoints and each codepoint of the first set of codepoints corresponds to a selected subset of spatial-domain basis indices, frequency-domain basis indices, time-domain basis indices, or a combination thereof; where the first set of codepoints is a subset of a second set of codepoints, each codepoint of the second set of codepoints corresponding to a subset of spatial-domain basis indices, frequency-domain basis indices, time-domain basis indices, or a combination thereof; where the multiple parameters comprise a set of entries corresponding to a bitmap that identifies reported coefficients with non-zero amplitude values; where each entry of the set of entries corresponds to a likelihood of a coefficient having a non-zero amplitude value; where the multiple parameters comprise a set of codepoints and each codepoint of the set of codepoints corresponds to at least one of a set of coefficient amplitude values and a set of coefficient phase values that are associated with multiple consecutive spatial-domain basis indices, multiple consecutive frequency-domain basis indices, multiple consecutive time-domain basis indices, or a combination thereof; where each codepoint of the set of codepoints is associated with one of two coefficient types, where a first coefficient type of the two coefficient types is associated with a first set of spatial-domain basis indices, frequency-domain basis indices, time-domain basis indices, or a combination thereof, and where a second coefficient type of the two coefficient types is associated with a second set of spatial-domain basis indices, frequency-domain basis indices, time-domain basis indices, or a combination thereof; where the first set of spatial-domain basis indices, frequency-domain basis indices, time-domain basis indices are associated with a strongest coefficient with a largest amplitude value; where the multiple parameters comprise a set of rank indicator values and each rank indicator value of the set of rank indicator values is associated with a distinct weight; where the multiple parameters comprise a set of channel quality indicator values and each channel quality indicator value of the set of channel quality indicator values is associated with a distinct weight; further including: obtaining a CSI report that is based on the training dataset report, where the CSI report includes parameters corresponding to spatial-domain basis indices, frequency-domain basis indices, time-domain basis indices, a bitmap indicator, a set of indicators corresponding to amplitude values of non-zero coefficients, a set of indicators corresponding to phase values of non-zero coefficients, a RI value, a CQI value, or a combination thereof, and each of the parameters of the CSI report is mapped to a set of values that are encoded via an encoding scheme based on the multiple weight values included in the training dataset report; and transmitting, to the device, a second signaling indicating the CSI report.

For example, the processor 604 may support wireless communication in accordance with examples as disclosed herein. The processor 604 includes at least one controller coupled with at least one memory, and is configured to or operable to cause the processor to: obtain a training dataset report corresponding to CSI based on a PMI codebook, where the training dataset report includes multiple parameters corresponding to the PMI codebook, the multiple parameters associated with multiple weight values; transmit, to a device, a first signaling indicating the training dataset report.

The processor 604 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 604 may be configured to operate a memory array using a memory controller. In some other implementations, a memory controller may be integrated into the processor 604. The processor 604 may be configured to execute computer-readable instructions stored in a memory (e.g., the memory 606) to cause the device 602 to perform various functions of the present disclosure.

The memory 606 may include random access memory (RAM) and read-only memory (ROM). The memory 606 may store computer-readable, computer-executable code including instructions that, when executed by the processor 604 cause the device 602 to perform various functions described herein. The code may be stored in a non-transitory computer-readable medium such as system memory or another type of memory. In some implementations, the code may not be directly executable by the processor 604 but may cause a computer (e.g., when compiled and executed) to perform functions described herein. In some implementations, the memory 606 may include, among other things, a basic I/O system (BIOS) which may control basic hardware or software operation such as the interaction with peripheral components or devices.

The I/O controller 610 may manage input and output signals for the device 602. The I/O controller 610 may also manage peripherals not integrated into the device 602. In some implementations, the I/O controller 610 may represent a physical connection or port to an external peripheral. In some implementations, the I/O controller 610 may utilize an operating system such as iOS®, ANDROID®, MS-DOS®, MS-WINDOWS®, OS/2®, UNIX®, LINUX®, or another known operating system. In some implementations, the I/O controller 610 may be implemented as part of a processor, such as the processor 604. In some implementations, a user may interact with the device 602 via the I/O controller 610 or via hardware components controlled by the I/O controller 610.

In some implementations, the device 602 may include a single antenna 612. However, in some other implementations, the device 602 may have more than one antenna 612 (i.e., multiple antennas), including multiple antenna panels or antenna arrays, which may be capable of concurrently transmitting or receiving multiple wireless transmissions. The transceiver 608 may communicate bi-directionally, via the one or more antennas 612, wired, or wireless links as described herein. For example, the transceiver 608 may represent a wireless transceiver and may communicate bi-directionally with another wireless transceiver. The transceiver 608 may also include a modem to modulate the packets, to provide the modulated packets to one or more antennas 612 for transmission, and to demodulate packets received from the one or more antennas 612.

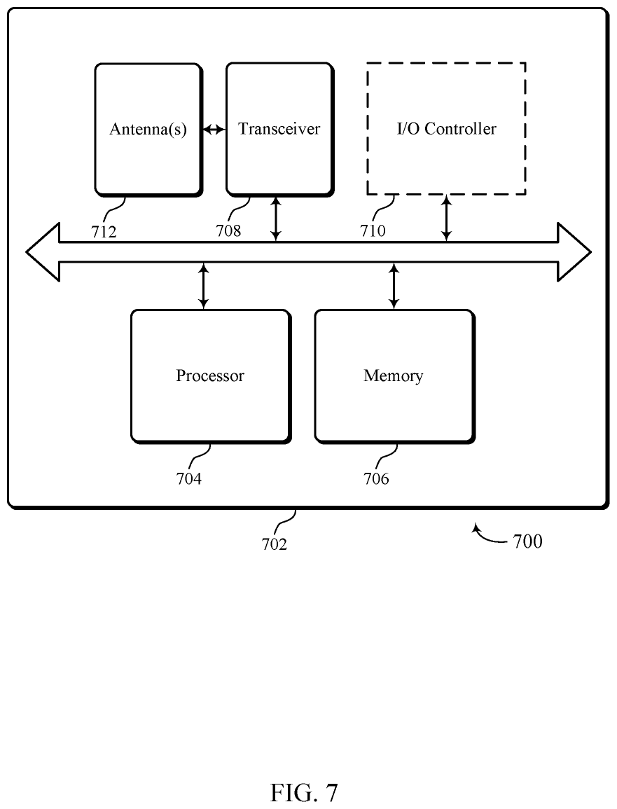

FIG. 7 illustrates an example of a block diagram 700 of a device 702 that supports codebook-based training dataset reports for channel state information in accordance with aspects of the present disclosure. The device 702 may be an example of a network entity 102 (or a UE 104) as described herein. The device 702 may support wireless communication with one or more network entities 102, UEs 104, or any combination thereof. The device 702 may include components for bi-directional communications including components for transmitting and receiving communications, such as a processor 704, a memory 706, a transceiver 708, and an I/O controller 710. These components may be in electronic communication or otherwise coupled (e.g., operatively, communicatively, functionally, electronically, electrically) via one or more interfaces (e.g., buses).

The processor 704, the memory 706, the transceiver 708, or various combinations thereof or various components thereof may be examples of means for performing various aspects of the present disclosure as described herein. For example, the processor 704, the memory 706, the transceiver 708, or various combinations or components thereof may support a method for performing one or more of the operations described herein.

In some implementations, the processor 704, the memory 706, the transceiver 708, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 704 and the memory 706 coupled with the processor 704 may be configured to perform one or more of the functions described herein (e.g., executing, by the processor 704, instructions stored in the memory 706).

For example, the processor 704 may support wireless communication at the device 702 in accordance with examples as disclosed herein. Processor 704 may be configured as or otherwise support to: receive, from a device, a first signaling indicating a training dataset report; where the training dataset report corresponds to CSI based on a PMI codebook, where the training dataset report includes multiple parameters corresponding to the PMI codebook, the multiple parameters associated with multiple weight values.

Additionally or alternatively, the processor 704 may be configured to or otherwise support: where the device comprises a user equipment, and the processor is further configured to cause the apparatus to receive the first signaling over a physical uplink channel; where the apparatus comprises a user equipment, and the processor is further configured to cause the apparatus to receive the first signaling over a physical downlink channel, to receive the first signaling as part of a higher-layer configuration information, or a combination thereof; where the multiple parameters comprise a first set of codepoints and each codepoint of the first set of codepoints corresponds to a selected subset of spatial-domain basis indices, frequency-domain basis indices, time-domain basis indices, or a combination thereof; where the first set of codepoints is a subset of a second set of codepoints, each codepoint of the second set of codepoints corresponding to a subset of spatial-domain basis indices, frequency-domain basis indices, time-domain basis indices, or a combination thereof; where the multiple parameters comprise a set of entries corresponding to a bitmap that identifies reported coefficients with non-zero amplitude values; where each entry of the set of entries corresponds to a likelihood of a coefficient having a non-zero amplitude value; where the multiple parameters comprise a set of codepoints and each codepoint of the set of codepoints corresponds to at least one of a set of coefficient amplitude values and a set of coefficient phase values that are associated with multiple consecutive spatial-domain basis indices, multiple consecutive frequency-domain basis indices, multiple consecutive time-domain basis indices, or a combination thereof; where each codepoint of the set of codepoints is associated with one of two coefficient types, where a first coefficient type of the two coefficient types is associated with a first set of spatial-domain basis indices, frequency-domain basis indices, time-domain basis indices, or a combination thereof, and where a second coefficient type of the two coefficient types is associated with a second set of spatial-domain basis indices, frequency-domain basis indices, time-domain basis indices, or a combination thereof; where the first set of spatial-domain basis indices, frequency-domain basis indices, time-domain basis indices are associated with a strongest coefficient with a largest amplitude value; where the multiple parameters comprise a set of rank indicator values and each rank indicator value of the set of rank indicator values is associated with a distinct weight; where the multiple parameters comprise a set of channel quality indicator values and each channel quality indicator value of the set of channel quality indicator values is associated with a distinct weight; where the processor is further configured to cause the apparatus to: receive, from the device, a second signaling indicating a CSI report; where the CSI report is based on the training dataset report, where the CSI report includes parameters corresponding to spatial-domain basis indices, frequency-domain basis indices, time-domain basis indices, a bitmap indicator, a set of indicators corresponding to amplitude values of non-zero coefficients, a set of indicators corresponding to phase values of non-zero coefficients, a RI value, a CQI value, or a combination thereof, and each of the parameters of the CSI report is mapped to a set of values that are encoded via an encoding scheme based on the multiple weight values included in the training dataset report.

For example, the processor 704 may support wireless communication at the device 702 in accordance with examples as disclosed herein. Processor 704 may be configured as or otherwise support a means for receiving, from a device, a first signaling indicating a training dataset report; and where the training dataset report corresponds to CSI based on a PMI codebook, where the training dataset report includes multiple parameters corresponding to the PMI codebook, the multiple parameters associated with multiple weight values.

Additionally or alternatively, the processor 704 may be configured to or otherwise support: where the device comprises a user equipment, and the method further comprises receiving the first signaling over a physical uplink channel; where the method is implemented in a user equipment, and the method further comprises receiving the first signaling over a physical downlink channel, receiving the first signaling as part of a higher-layer configuration information, or a combination thereof; where the multiple parameters comprise a first set of codepoints and each codepoint of the first set of codepoints corresponds to a selected subset of spatial-domain basis indices, frequency-domain basis indices, time-domain basis indices, or a combination thereof; where the first set of codepoints is a subset of a second set of codepoints, each codepoint of the second set of codepoints corresponding to a subset of spatial-domain basis indices, frequency-domain basis indices, time-domain basis indices, or a combination thereof; where the multiple parameters comprise a set of entries corresponding to a bitmap that identifies reported coefficients with non-zero amplitude values; where each entry of the set of entries corresponds to a likelihood of a coefficient having a non-zero amplitude value; Additionally or alternatively, the processor 704 may be configured to or otherwise support: where the multiple parameters comprise a set of codepoints and each codepoint of the set of codepoints corresponds to at least one of a set of coefficient amplitude values and a set of coefficient phase values that are associated with multiple consecutive spatial-domain basis indices, multiple consecutive frequency-domain basis indices, multiple consecutive time-domain basis indices, or a combination thereof; Additionally or alternatively, the processor 704 may be configured to or otherwise support: where each codepoint of the set of codepoints is associated with one of two coefficient types, where a first coefficient type of the two coefficient types is associated with a first set of spatial-domain basis indices, frequency-domain basis indices, time-domain basis indices, or a combination thereof, and where a second coefficient type of the two coefficient types is associated with a second set of spatial-domain basis indices, frequency-domain basis indices, time-domain basis indices, or a combination thereof; where the first set of spatial-domain basis indices, frequency-domain basis indices, time-domain basis indices are associated with a strongest coefficient with a largest amplitude value; Additionally or alternatively, the processor 704 may be configured to or otherwise support: where the multiple parameters comprise a set of rank indicator values and each rank indicator value of the set of rank indicator values is associated with a distinct weight; Additionally or alternatively, the processor 704 may be configured to or otherwise support: where the multiple parameters comprise a set of channel quality indicator values and each channel quality indicator value of the set of channel quality indicator values is associated with a distinct weight; receiving, from the device, a second signaling indicating a CSI report; where the CSI report is based on the training dataset report, where the CSI report includes parameters corresponding to spatial-domain basis indices, frequency-domain basis indices, time-domain basis indices, a bitmap indicator, a set of indicators corresponding to amplitude values of non-zero coefficients, a set of indicators corresponding to phase values of non-zero coefficients, a RI value, a CQI value, or a combination thereof, and each of the parameters of the CSI report is mapped to a set of values that are encoded via an encoding scheme based on the multiple weight values included in the training dataset report.

For example, the processor 704 may support wireless communication in accordance with examples as disclosed herein. The processor 704 includes at least one controller coupled with at least one memory, and is configured to or operable to cause the processor to: receive, from a device, a first signaling indicating a training dataset report; where the training dataset report corresponds to CSI based on a PMI codebook, where the training dataset report includes multiple parameters corresponding to the PMI codebook, the multiple parameters associated with multiple weight values.

The processor 704 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 704 may be configured to operate a memory array using a memory controller. In some other implementations, a memory controller may be integrated into the processor 704. The processor 704 may be configured to execute computer-readable instructions stored in a memory (e.g., the memory 706) to cause the device 702 to perform various functions of the present disclosure.

The memory 706 may include random access memory (RAM) and read-only memory (ROM). The memory 706 may store computer-readable, computer-executable code including instructions that, when executed by the processor 704 cause the device 702 to perform various functions described herein. The code may be stored in a non-transitory computer-readable medium such as system memory or another type of memory. In some implementations, the code may not be directly executable by the processor 704 but may cause a computer (e.g., when compiled and executed) to perform functions described herein. In some implementations, the memory 706 may include, among other things, a basic I/O system (BIOS) which may control basic hardware or software operation such as the interaction with peripheral components or devices.

The I/O controller 710 may manage input and output signals for the device 702. The I/O controller 710 may also manage peripherals not integrated into the device 702. In some implementations, the I/O controller 710 may represent a physical connection or port to an external peripheral. In some implementations, the I/O controller 710 may utilize an operating system such as iOS®, ANDROID®, MS-DOS®, MS-WINDOWS®, OS/2®, UNIX®, LINUX®, or another known operating system. In some implementations, the I/O controller 710 may be implemented as part of a processor, such as the processor 704. In some implementations, a user may interact with the device 702 via the I/O controller 710 or via hardware components controlled by the I/O controller 710.

In some implementations, the device 702 may include a single antenna 712. However, in some other implementations, the device 702 may have more than one antenna 712 (i.e., multiple antennas), including multiple antenna panels or antenna arrays, which may be capable of concurrently transmitting or receiving multiple wireless transmissions. The transceiver 708 may communicate bi-directionally, via the one or more antennas 712, wired, or wireless links as described herein. For example, the transceiver 708 may represent a wireless transceiver and may communicate bi-directionally with another wireless transceiver. The transceiver 708 may also include a modem to modulate the packets, to provide the modulated packets to one or more antennas 712 for transmission, and to demodulate packets received from the one or more antennas 712.

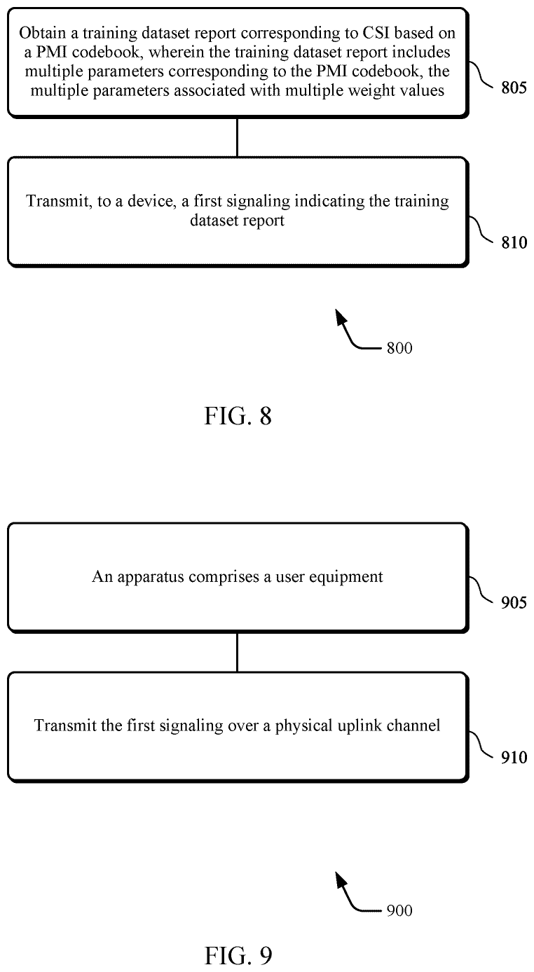

FIG. 8 illustrates a flowchart of a method 800 that supports codebook-based training dataset reports for channel state information in accordance with aspects of the present disclosure. The operations of the method 800 may be implemented by a device or its components as described herein. For example, the operations of the method 800 may be performed by a UE 104 (or a network entity 102) as described with reference to FIGS. 1 through 7. In some implementations, the device may execute a set of instructions to control the function elements of the device to perform the described functions. Additionally, or alternatively, the device may perform aspects of the described functions using special-purpose hardware.

At 805, the method may include obtaining a training dataset report corresponding to CSI based on a PMI codebook, wherein the training dataset report includes multiple parameters corresponding to the PMI codebook, the multiple parameters associated with multiple weight values. The operations of 805 may be performed in accordance with examples as described herein. In some implementations, aspects of the operations of 805 may be performed by a device as described with reference to FIG. 1.

At 810, the method may include transmitting, to a device, a first signaling indicating the training dataset report. The operations of 810 may be performed in accordance with examples as described herein. In some implementations, aspects of the operations of 810 may be performed by a device as described with reference to FIG. 1.

FIG. 9 illustrates a flowchart of a method 900 that supports codebook-based training dataset reports for channel state information in accordance with aspects of the present disclosure. The operations of the method 900 may be implemented by a device or its components as described herein. For example, the operations of the method 900 may be performed by a UE 104 (or a network entity 102) as described with reference to FIGS. 1 through 7. In some implementations, the device may execute a set of instructions to control the function elements of the device to perform the described functions. Additionally, or alternatively, the device may perform aspects of the described functions using special-purpose hardware.

At 905, the method may include an apparatus comprises a user equipment. The operations of 905 may be performed in accordance with examples as described herein. In some implementations, aspects of the operations of 905 may be performed by a device as described with reference to FIG. 1.

At 910, the method may include transmitting the first signaling over a physical uplink channel. The operations of 910 may be performed in accordance with examples as described herein. In some implementations, aspects of the operations of 910 may be performed by a device as described with reference to FIG. 1.

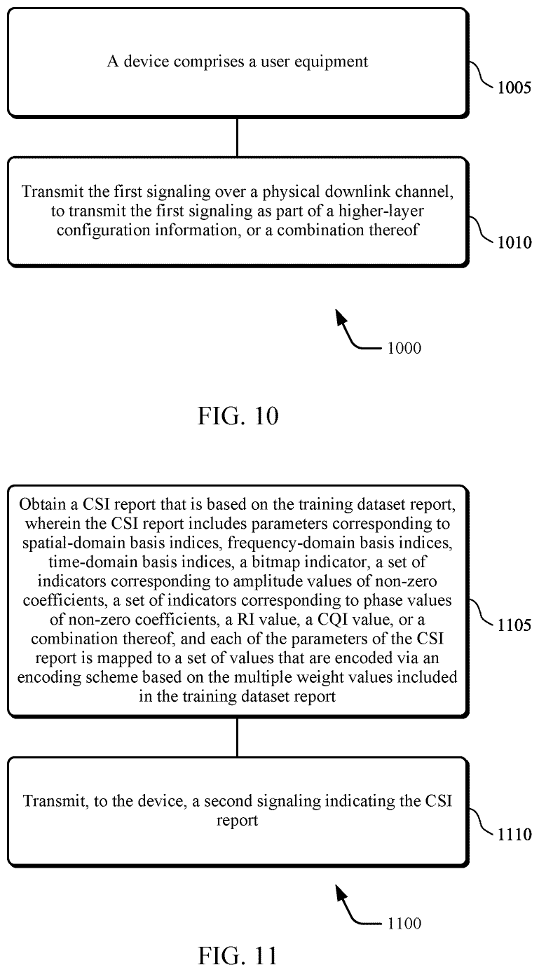

FIG. 10 illustrates a flowchart of a method 1000 that supports codebook-based training dataset reports for channel state information in accordance with aspects of the present disclosure. The operations of the method 1000 may be implemented by a device or its components as described herein. For example, the operations of the method 1000 may be performed by a UE 104 (or a network entity 102) as described with reference to FIGS. 1 through 7. In some implementations, the device may execute a set of instructions to control the function elements of the device to perform the described functions. Additionally, or alternatively, the device may perform aspects of the described functions using special-purpose hardware.

At 1005, the method may include a device comprises a user equipment. The operations of 1005 may be performed in accordance with examples as described herein. In some implementations, aspects of the operations of 1005 may be performed by a device as described with reference to FIG. 1.

At 1010, the method may include transmitting the first signaling over a physical downlink channel, to transmit the first signaling as part of a higher-layer configuration information, or a combination thereof. The operations of 1010 may be performed in accordance with examples as described herein. In some implementations, aspects of the operations of 1010 may be performed by a device as described with reference to FIG. 1.

FIG. 11 illustrates a flowchart of a method 1100 that supports codebook-based training dataset reports for channel state information in accordance with aspects of the present disclosure. The operations of the method 1100 may be implemented by a device or its components as described herein. For example, the operations of the method 1100 may be performed by a UE 104 (or a network entity 102) as described with reference to FIGS. 1 through 7. In some implementations, the device may execute a set of instructions to control the function elements of the device to perform the described functions. Additionally, or alternatively, the device may perform aspects of the described functions using special-purpose hardware.

At 1105, the method may include obtaining a CSI report that is based on the training dataset report, wherein the CSI report includes parameters corresponding to spatial-domain basis indices, frequency-domain basis indices, time-domain basis indices, a bitmap indicator, a set of indicators corresponding to amplitude values of non-zero coefficients, a set of indicators corresponding to phase values of non-zero coefficients, a RI value, a CQI value, or a combination thereof, and each of the parameters of the CSI report is mapped to a set of values that are encoded via an encoding scheme based on the multiple weight values included in the training dataset report. The operations of 1105 may be performed in accordance with examples as described herein. In some implementations, aspects of the operations of 1105 may be performed by a device as described with reference to FIG. 1.

At 1110, the method may include transmitting, to the device, a second signaling indicating the CSI report. The operations of 1110 may be performed in accordance with examples as described herein. In some implementations, aspects of the operations of 1110 may be performed by a device as described with reference to FIG. 1.

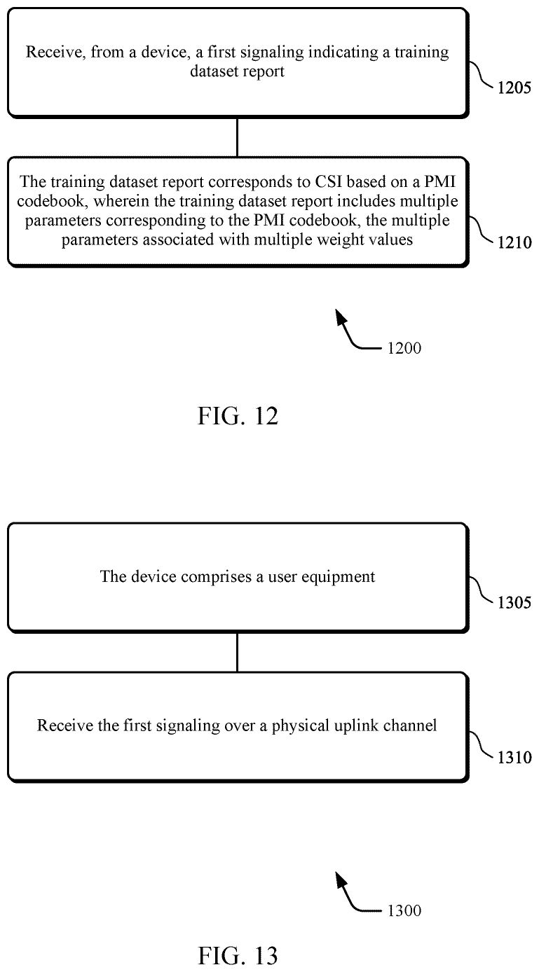

FIG. 12 illustrates a flowchart of a method 1200 that supports codebook-based training dataset reports for channel state information in accordance with aspects of the present disclosure. The operations of the method 1200 may be implemented by a device or its components as described herein. For example, the operations of the method 1200 may be performed by a network entity 102 (or a UE 104) as described with reference to FIGS. 1 through 7. In some implementations, the device may execute a set of instructions to control the function elements of the device to perform the described functions. Additionally, or alternatively, the device may perform aspects of the described functions using special-purpose hardware.

At 1205, the method may include receiving, from a device, a first signaling indicating a training dataset report. The operations of 1205 may be performed in accordance with examples as described herein. In some implementations, aspects of the operations of 1205 may be performed by a device as described with reference to FIG. 1.

At 1210, the method may include the training dataset report corresponds to CSI based on a PMI codebook, wherein the training dataset report includes multiple parameters corresponding to the PMI codebook, the multiple parameters associated with multiple weight values. The operations of 1210 may be performed in accordance with examples as described herein. In some implementations, aspects of the operations of 1210 may be performed by a device as described with reference to FIG. 1.

FIG. 13 illustrates a flowchart of a method 1300 that supports codebook-based training dataset reports for channel state information in accordance with aspects of the present disclosure. The operations of the method 1300 may be implemented by a device or its components as described herein. For example, the operations of the method 1300 may be performed by a network entity 102 (or a UE 104) as described with reference to FIGS. 1 through 7. In some implementations, the device may execute a set of instructions to control the function elements of the device to perform the described functions. Additionally, or alternatively, the device may perform aspects of the described functions using special-purpose hardware.

At 1305, the method may include the device comprises a user equipment. The operations of 1305 may be performed in accordance with examples as described herein. In some implementations, aspects of the operations of 1305 may be performed by a device as described with reference to FIG. 1.

At 1310, the method may include receiving the first signaling over a physical uplink channel. The operations of 1310 may be performed in accordance with examples as described herein. In some implementations, aspects of the operations of 1310 may be performed by a device as described with reference to FIG. 1.

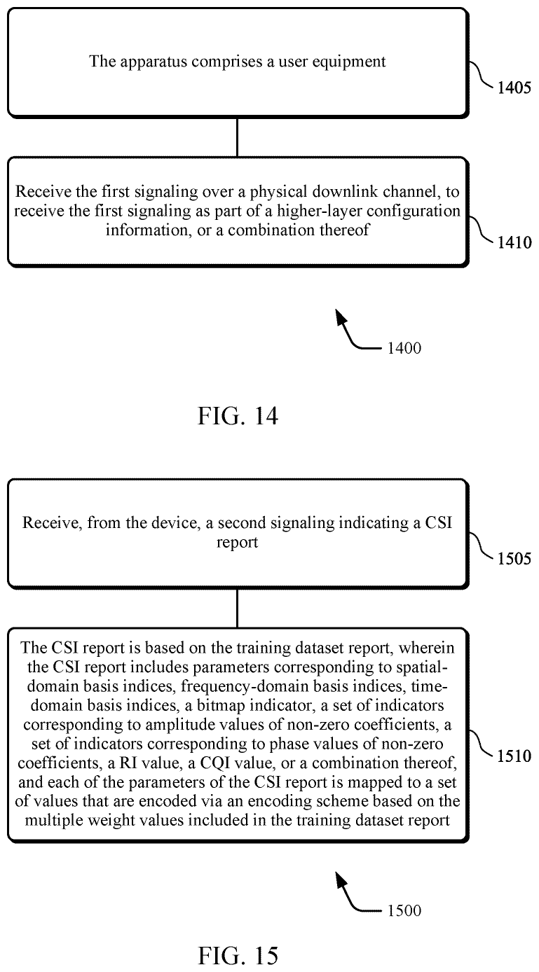

FIG. 14 illustrates a flowchart of a method 1400 that supports codebook-based training dataset reports for channel state information in accordance with aspects of the present disclosure. The operations of the method 1400 may be implemented by a device or its components as described herein. For example, the operations of the method 1400 may be performed by a network entity 102 (or a UE 104) as described with reference to FIGS. 1 through 7. In some implementations, the device may execute a set of instructions to control the function elements of the device to perform the described functions. Additionally, or alternatively, the device may perform aspects of the described functions using special-purpose hardware.

At 1405, the method may include the apparatus comprises a user equipment. The operations of 1405 may be performed in accordance with examples as described herein. In some implementations, aspects of the operations of 1405 may be performed by a device as described with reference to FIG. 1.

At 1410, the method may include receiving the first signaling over a physical downlink channel, to receive the first signaling as part of a higher-layer configuration information, or a combination thereof. The operations of 1410 may be performed in accordance with examples as described herein. In some implementations, aspects of the operations of 1410 may be performed by a device as described with reference to FIG. 1.

FIG. 15 illustrates a flowchart of a method 1500 that supports codebook-based training dataset reports for channel state information in accordance with aspects of the present disclosure. The operations of the method 1500 may be implemented by a device or its components as described herein. For example, the operations of the method 1500 may be performed by a network entity 102 (or a UE 104) as described with reference to FIGS. 1 through 7. In some implementations, the device may execute a set of instructions to control the function elements of the device to perform the described functions. Additionally, or alternatively, the device may perform aspects of the described functions using special-purpose hardware.

At 1505, the method may include receiving the first signaling over a physical downlink channel, to receive the first signaling as part of a higher-layer configuration information, or a combination thereof. The operations of 1505 may be performed in accordance with examples as described herein. In some implementations, aspects of the operations of 1505 may be performed by a device as described with reference to FIG. 1.

At 1510, the method may include the CSI report is based on the training dataset report, wherein the CSI report includes parameters corresponding to spatial-domain basis indices, frequency-domain basis indices, time-domain basis indices, a bitmap indicator, a set of indicators corresponding to amplitude values of non-zero coefficients, a set of indicators corresponding to phase values of non-zero coefficients, a RI value, a CQI value, or a combination thereof, and each of the parameters of the CSI report is mapped to a set of values that are encoded via an encoding scheme based on the multiple weight values included in the training dataset report. The operations of 1510 may be performed in accordance with examples as described herein. In some implementations, aspects of the operations of 1510 may be performed by a device as described with reference to FIG. 1.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Similarly, a list of at least one of A; B; or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication, comprising:
at least one memory; and
at least one processor coupled with the at least one memory and configured to cause the apparatus to:
obtain a training dataset report that corresponds to channel state information (CSI) based at least in part on a precoding matrix indicator (PMI) codebook, wherein the training dataset report includes multiple parameters that correspond to the PMI codebook, and wherein the multiple parameters are associated with multiple weight values;
transmit the training dataset report.

2. The apparatus of claim 1, wherein the apparatus comprises a user equipment (UE), and the at least one processor is further configured to cause the apparatus to transmit the training dataset report over a physical uplink channel.

3. The apparatus of claim 1, wherein the at least one processor is further configured to cause the apparatus to at least one of transmit the training dataset report over a physical downlink channel, or transmit the training dataset report as part of a higher-layer configuration information.

4. The apparatus of claim 1, wherein the multiple parameters comprise a first set of codepoints and each codepoint of the first set of codepoints corresponds to at least one of a selected subset of spatial-domain basis indices, frequency-domain basis indices, or time-domain basis indices.

5. The apparatus of claim 4, wherein the first set of codepoints is a subset of a second set of codepoints, and wherein each codepoint of the second set of codepoints corresponds to at least one of a subset of spatial-domain basis indices, frequency-domain basis indices, or time-domain basis indices.

6. The apparatus of claim 1, wherein the multiple parameters comprise a set of entries that corresponds to a bitmap that identifies reported coefficients with non-zero amplitude values.

7. The apparatus of claim 6, wherein each entry of the set of entries corresponds to a likelihood of a coefficient having a non-zero amplitude value.

8. The apparatus of claim 1, wherein the multiple parameters comprise a set of codepoints and each codepoint of the set of codepoints corresponds to at least one of a set of coefficient amplitude values and a set of coefficient phase values that are associated with at least one of multiple consecutive spatial-domain basis indices, multiple consecutive frequency-domain basis indices, or multiple consecutive time-domain basis indices.

9. The apparatus of claim 8, wherein each codepoint of the set of codepoints is associated with one of two coefficient types, wherein a first coefficient type of the two coefficient types is associated with at least one of a first set of spatial-domain basis indices, frequency-domain basis indices, or time-domain basis indices, and wherein a second coefficient type of the two coefficient types is associated with at least one of a second set of spatial-domain basis indices, frequency-domain basis indices, or time-domain basis indices.

10. The apparatus of claim 9, wherein the first set of spatial-domain basis indices, frequency-domain basis indices, or time-domain basis indices are associated with a strongest coefficient with a largest amplitude value.

11. The apparatus of claim 1, wherein the multiple parameters comprise a set of rank indicator values and each rank indicator value of the set of rank indicator values is associated with a distinct weight.

12. The apparatus of claim 1, wherein the multiple parameters comprise a set of channel quality indicator values and each channel quality indicator value of the set of channel quality indicator values is associated with a distinct weight.

13. The apparatus of claim 1, wherein the at least one processor is further configured to cause the apparatus to:
obtain a CSI report that is based at least in part on the training dataset report, wherein the CSI report includes parameters that correspond to at least one of spatial-domain basis indices, frequency-domain basis indices, time-domain basis indices, a bitmap indicator, a set of indicators that correspond to amplitude values of non-zero coefficients, a set of indicators that correspond to phase values of non-zero coefficients, a rank indicator (RI) value, or a channel quality indicator (CQI) value, and each of the parameters of the CSI report is mapped to a set of values that are encoded via an encoding scheme based at least in part on the multiple weight values included in the training dataset report; and
transmit the CSI report.

14. An apparatus for wireless communication, comprising:
at least one memory; and
at least one processor coupled with the at least one memory and configured to cause the apparatus to:
receive a training dataset report;
wherein the training dataset report corresponds to channel state information (CSI) based at least in part on a precoding matrix indicator (PMI) codebook, wherein the training dataset report includes multiple parameters that correspond to the PMI codebook, and wherein the multiple parameters are associated with multiple weight values.

15. The apparatus of claim 14, wherein the multiple parameters comprise a first set of codepoints and each codepoint of the first set of codepoints corresponds to at least one of a selected subset of spatial-domain basis indices, frequency-domain basis indices, or time-domain basis indices.

16. A method performed by an apparatus, the method comprising:
obtaining a training dataset report that corresponds to channel state information (CSI) based at least in part on a precoding matrix indicator (PMI) codebook, wherein the training dataset report includes multiple parameters that correspond to the PMI codebook, and wherein the multiple parameters are associated with multiple weight values; and
transmitting the training dataset report.

17-20. (canceled)

21. The method of claim 16, wherein the apparatus comprises a user equipment (UE), the method further comprises transmitting the training dataset report over a physical uplink channel.

22. The method of claim 16, further comprising at least one of transmitting the training dataset report over a physical downlink channel, or transmitting the training dataset report as part of a higher-layer configuration information.

23. A method performed by an apparatus, the method comprising:
receiving a training dataset report; and
wherein the training dataset report corresponds to channel state information (CSI) based at least in part on a precoding matrix indicator (PMI) codebook, wherein the training dataset report includes multiple parameters that correspond to the PMI codebook, and wherein the multiple parameters are associated with multiple weight values.

24. The method of claim 23, wherein the multiple parameters comprise a first set of codepoints and each codepoint of the first set of codepoints corresponds to at least one of a selected subset of spatial-domain basis indices, frequency-domain basis indices, or time-domain basis indices.
